(19) United States
(12) Patent Application Publication
(10) Pub. No.: US 2013/0120713 A1
(43) Pub. Date: May 16, 2013

(54) PROJECTION APPARATUS

(71) Applicant: Sony Corporation, Tokyo (JP)

(72) Inventors: Keisuke Homma, Kanagawa (JP); Katsumi Muramatsu, Aichi (JP)

(73) Assignee: Sony Corporation, Tokyo (JP)

(21) Appl. No.: 13/669,929

(22) Filed: Nov. 6, 2012

(30) Foreign Application Priority Data
Nov. 11, 2011 (JP) 2011-247055

(51) Int. Cl. G03B 21/14

(52) U.S. Cl. 353/20

(57) ABSTRACT

There is provided a projection apparatus including a color synthesis section, a projection lens, and a polarization conversion section. The color synthesis section is configured to combine three-primary color light. The projection lens is configured to emit light provided by the color synthesis section. The polarization conversion section is disposed on a light-emission side of the projection lens and is configured to put the color light provided by the projection lens in a non-polarized state.

### BACKGROUND

The present technology relates to a projection apparatus performing a video display.

### SUMMARY

There has recently developed an LCD (Liquid Crystal Display) projector adopting the 3D (three-dimensional) active shutter technology.

The active shutter technology belongs to the video display technology with which sense of depth is created. With such an active shutter technology, stereoscopic viewing is achieved with parallax, which is created by alternately displaying a left-eye picture and a right-eye picture, and in synchronization with switching of the pictures, by alternately blocking the user's right and left eyes view of 3D glasses.

The issue here is that such a projector projecting 3D images as described above has a difficulty in quality control compared with a projector projecting 2D (two-dimensional) images. This is because, as for light polarized after reflection on a screen, the 3D glasses pass therethrough only components polarized in a specific direction, and this polarization state greatly affects the quality of the 3D images, i.e., causes color unevenness, and reduction of brightness.

With 2D images, the 3D glasses are not used, and thus the image quality is not affected by the polarization state of light after reflection on the screen because the light is directed into user's eyes uniformly irrespective of the polarization state. On the other hand, with an LCD projector or others adopting the 3D active shutter technology, an important factor is to give consideration to the polarization state of light before the light reaches the 3D glasses.

As a previous technology, proposed is a projection display apparatus that makes uniform the amount of RGB (Red, Green, and Blue) light in the horizontal/vertical directions, and changes the polarization state of each of the color light. As an example, see Japanese Patent Application Laid-open No. 2007-304607.

With the previous projector projecting 3D images, however, before projection light therefrom reaches the 3D glasses after being reflected on the screen, no appropriate polarization conversion process is performed on the light for improving the quality of the 3D images.

There thus is a problem that a user perceives the 3D images being uneven in color when the 3D glasses are not tilted, and when the 3D glasses are tilted, the user perceives the 3D images not only being uneven in color but also being reduced in brightness.

In view of the circumstances as described above, it is thus desirable to provide a projection apparatus that considerably improves the quality of 3D images with color unevenness made less conspicuous when 3D glasses are not tilted, and with color unevenness made less conspicuous and brightness made less reduced when the 3D glasses are tilted.

According to an embodiment of the present technology, there is provided a projection apparatus. This projection apparatus includes a color synthesis section, a projection lens, and a polarization conversion section. The color synthesis section is configured to combine three-primary color light. The projection lens is configured to emit light provided by the color synthesis section. The polarization conversion section is disposed on a light-emission side of the projection lens, the polarization conversion section being configured to put the color light provided by the projection lens in a non-polarized state.

The quality of 3D images is thus to be considerably improved.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a diagram showing an exemplary configuration of a projection apparatus;

FIG. 2 is a diagram showing factors that change the polarization state of light;

FIG. 3 is a diagram illustrating color unevenness observed via 3D glasses;

FIG. 4 is another diagram illustrating color unevenness observed via the 3D glasses;

FIG. 5 is a diagram showing an exemplary optical unit configuration of a transmissive LCD projector;

FIG. 6 is a diagram showing an exemplary optical unit configuration of a reflective LCD projector;

FIG. 7 is a diagram showing a wavelength-selective half waveplate;

FIG. 8 is a diagram for illustrating the characteristics of the wavelength-selective half waveplate;

FIG. 9 is a diagram showing a uniaxial organic material and a uniaxial crystal;

FIG. 10 is a diagram for illustrating the characteristics of the uniaxial organic material and those of the uniaxial crystal;

FIG. 11 is a diagram showing the polarization state of light affected by phase retardation of the uniaxial organic material and that of the uniaxial crystal;

FIG. 12 is a diagram showing an exemplary configuration of a projection apparatus;

FIG. 13 is a diagram showing another exemplary configuration of the projection apparatus;

FIG. 14 is a diagram showing still another exemplary configuration of the projection apparatus;

FIG. 15 is a diagram showing still another exemplary configuration of the projection apparatus;

FIG. 16 is a diagram showing still another exemplary configuration of the projection apparatus;

FIG. 17 is a diagram showing still another exemplary configuration of the projection apparatus;

FIG. 18 is a diagram showing still another exemplary configuration of the projection apparatus;

FIG. 19 is a diagram showing still another exemplary configuration of the projection apparatus;

FIG. 20 is a diagram showing still another exemplary configuration of the projection apparatus;

FIG. 21 is a diagram showing still another exemplary configuration of the projection apparatus;

FIG. 22 is a diagram showing still another exemplary configuration of the projection apparatus;

FIG. 23 is a diagram showing still another exemplary configuration of the projection apparatus;

FIG. 24 is a diagram showing an exemplary placement;

FIG. 25 is a diagram showing another exemplary placement;

FIG. 26 is a diagram showing still another exemplary placement;

FIG. 27 is a diagram showing an exemplary projection state;

FIG. 28 is a diagram showing another exemplary projection state;

FIG. 29 is a diagram showing still another exemplary projection state;

FIG. 30 is a diagram showing still another exemplary projection state; and

FIG. 31 is a conceptual view of projection by the projection apparatus.

### DETAILED DESCRIPTION OF EMBODIMENT

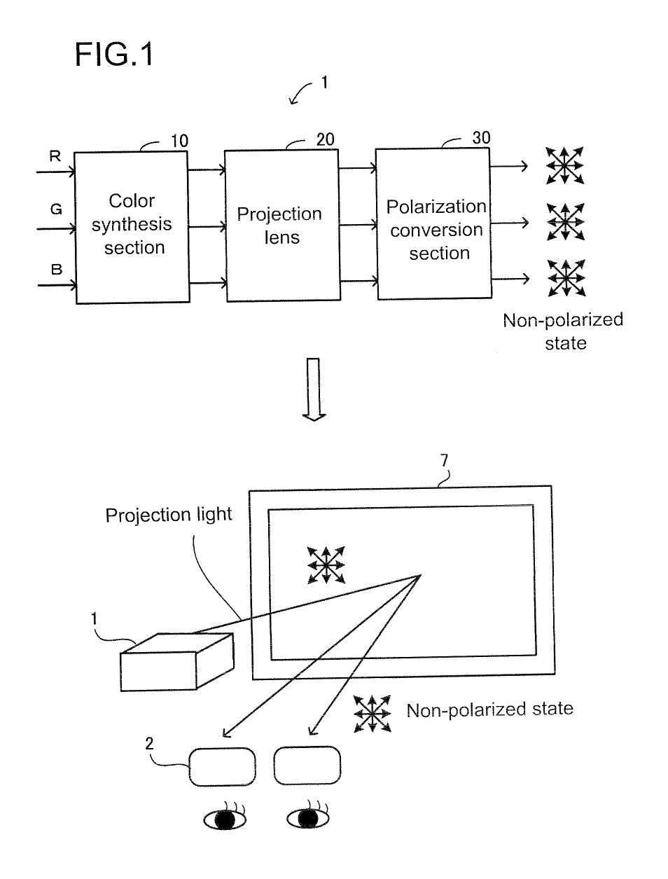

Hereinafter, an embodiment of the present disclosure will be described with reference to the drawings. FIG. 1 is a diagram showing an exemplary configuration of a projection apparatus. A projection apparatus 1 includes a color synthesis section 10, a projection lens 20, and a polarization conversion section 30.

The color synthesis section 10 combines light in three primary colors of R (Red), G (Green), and B (Blue). The projection lens 20 emits the light provided by the color synthesis section 10. The polarization conversion section 30 is disposed on the light-emission side of the projection lens 20, and puts each color light provided by the projection lens 20 in a non-polarized state.

In this example, the polarization conversion section 30 is provided with a polarization conversion element, which is any one of a wavelength-selective half waveplate, a uniaxial organic material, and a uniaxial crystal. The wavelength-selective half waveplate produces a phase shift of π with respect to light with a predetermined wavelength. The uniaxial organic material is an organic material having one optical axis, and the uniaxial crystal is a crystal having one optical axis. With the use of such polarization conversion elements, each color light coming from the projection lens 20 is polarized differently on a wavelength basis so that the light is put in the non-polarized state.

As such, the projection apparatus 1 is provided with the color synthesis section 10, the projection lens 20, and the polarization conversion section 30. The polarization conversion section 30 is configured to put the color light coming from the projection lens 20 in the non-polarized state.

With this configuration, the light directed by the projection apparatus 1 toward a screen 7 is in the non-polarized state, and the light entering user's 3D glasses 2 after being reflected on the screen 7 is also in the non-polarized state.

This considerably improves the quality of 3D images with color unevenness made less conspicuous when the 3D glasses 2 are not tilted, and with color unevenness made less conspicuous and brightness made less reduced when the 3D glasses 2 are tilted.

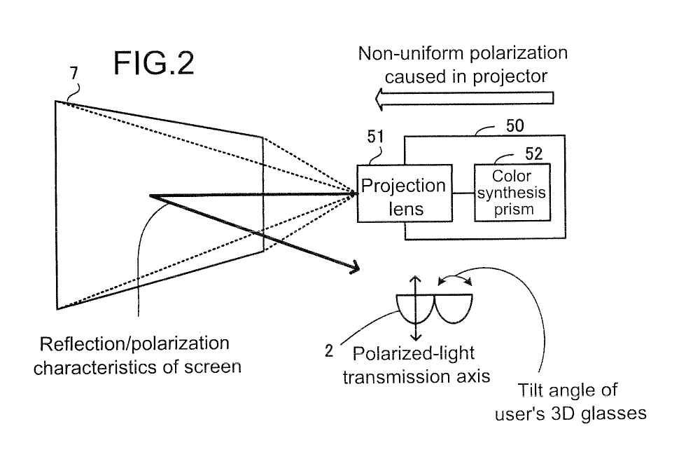

Described next in detail are problems to be solved by the present technology. FIG. 2 is a diagram showing factors that change the polarization state of light. In a projection apparatus (projector) 50, light coming from a projection lens 51 is reflected on the screen 7, and then reaches the 3D glasses 2. The polarization state of the light entering the 3D glasses 2 is affected mainly by three factors as below.

1. Non-Uniform Polarization Caused in Projector 50

The light is polarized non-uniformly in the projector 50, specifically in the part from a color synthesis prism 52 to the projection lens 51. The non-uniform polarization is caused specifically by the projection lens 51 no matter if the projection lens 51 is a glass or a plastic lens.

When the projection lens 51 is a glass lens, factors affecting the light to be non-uniformly polarized include the material, the shape, the AR (Anti Reflection) coating, and others of the glass lens. When the projection lens 51 is a plastic lens, factors affecting the light to be non-uniformly polarized include the material, the shape, the AR coating, the molding conditions, and others of the plastic lens. Especially with a plastic lens, the non-uniformity of polarization is very conspicuous.

2. Reflection/Polarization Characteristics of Screen 7

When the screen 7 is specifically a silver screen, incoming light remains in the same polarization state when it is reflected thereon. Therefore, the non-uniformity of polarization caused by the above-described factor 1 in the projector 50 directly affects the quality of the 3D images. Moreover, if the screen is with any in-plane non-uniformity being the polarization characteristics, the screen is directly affected by the factor 3 below.

3. Tilt Angle of User's 3D Glasses 2

As for the 3D glasses 2 under the normal use, the tilt angle thereof with respect to a polarized-light transmission axis is about ±25° when the user tilts his/her head. When the 3D glasses 2 are tilted at the angle of about ±25° because the user tilts his/her head, the 3D glasses 2 are changed also in transmission direction for the polarized light. As a result, this also greatly changes the quality of the 3D images.

Due to the polarization-state-changing factors of 1 to 3 above, the light entering the 3D glasses 2 is changed in polarization state, and there thus have previously been two main problems as below.

A. In 3D images, color unevenness is perceivable when the 3D glasses 2 are not tilted.

B. In 3D images, color unevenness and brightness reduction are perceivable when the 3D glasses 2 are tilted.

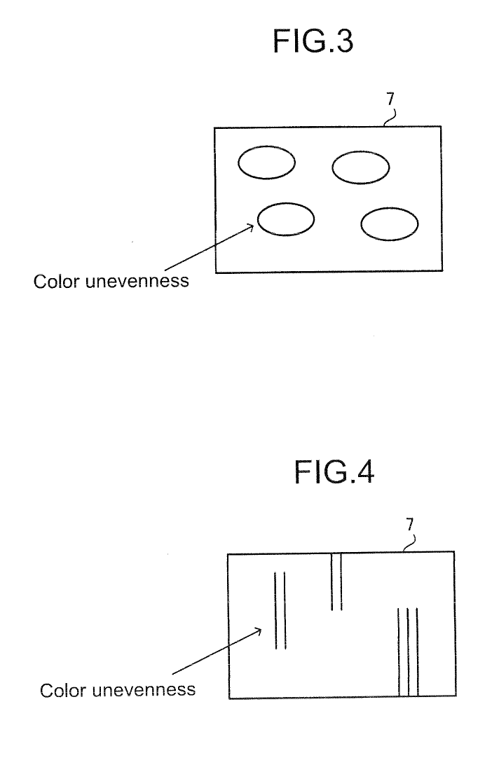

FIGS. 3 and 4 are each a diagram illustrating color unevenness to be perceived via 3D glasses. Such color unevenness as shown in FIG. 3 (indicated by elliptical figures) may be observed on the screen 7, e.g., when the background is white in color. When the screen 7 is with any in-plane non-uniformity being the polarization characteristics, for example, the user may perceive such linear color unevenness as shown in FIG. 4 when the user tilts his/her head.

In order to solve the previous problems of A and B, the polarization-state-changing factor of 1 is expected to be used for a solution. This is because, with the polarization-state-changing factor of 2, there is no way to ask the user (customer) to use the screen 7 of a specific type. With the polarization-state-changing factor of 3, using specifically-designed 3D glasses is not practical considering the recent trend toward standardization of the 3D glasses 2.

For problem solving by the polarization-state-changing factor of 1, the problem of A is solved by the following approaches #1 to #3.

#1. Use the projection lens 51 being a lens entirely made of glass, i.e., avoid use of a plastic lens. However, this indeed solves the problem of A but not the problem of B.

#2. When the color synthesis prism 52 is an SPS model, provide a wavelength-selective half waveplate (Color Select) between the projection lens 51 and the color synthesis prism 52. Using the wavelength-selective half waveplate, S-polarized light/P-polarized light/S-polarized light is aligned in order of RGB to have P-polarized light/P-polarized light/P-polarized light, or S-polarized light/S-polarized light/S-polarized light. However, this indeed solves the problem of A but not the problem of B.

As for a color synthesis prism generally used in a projector, an SPS model is more popular than an SSS model because green light is higher in transmittance when it is P-polarized than when it is S-polarized. However, the SSS model is also used for polarization alignment of RGB light after it is emitted from the color synthesis prism.

#3. Use the color synthesis prism 52 of an SSS model. However, this indeed solves the problem of A but not the problem of B. Moreover, this considerably reduces the transmittance of G (Green), thereby greatly reducing the 2D brightness.

As such, for solving the problem of A, the approaches #1 to #3 as above are available each as a solution. However, these approaches #1 to #3 do not solve the problem of B. This is because, with the approaches #1 to #3, the RGB light is simply linearly polarized in the same direction, and the light coming from the projector 50 is not put in the non-polarized state (no one has found out that putting the light in this non-polarized state is a solution).

In view of the circumstances as described above, it is thus desirable to provide the projection apparatus 1 that considerably improves the quality of 3D images with color unevenness made less conspicuous when the 3D glasses 2 are not tilted, and with color unevenness made less conspicuous and brightness made less reduced when the 3D glasses 2 are tilted.

Described next is a transmissive LCD projector, and a reflective LCD projector as application examples of the projection apparatus 1.

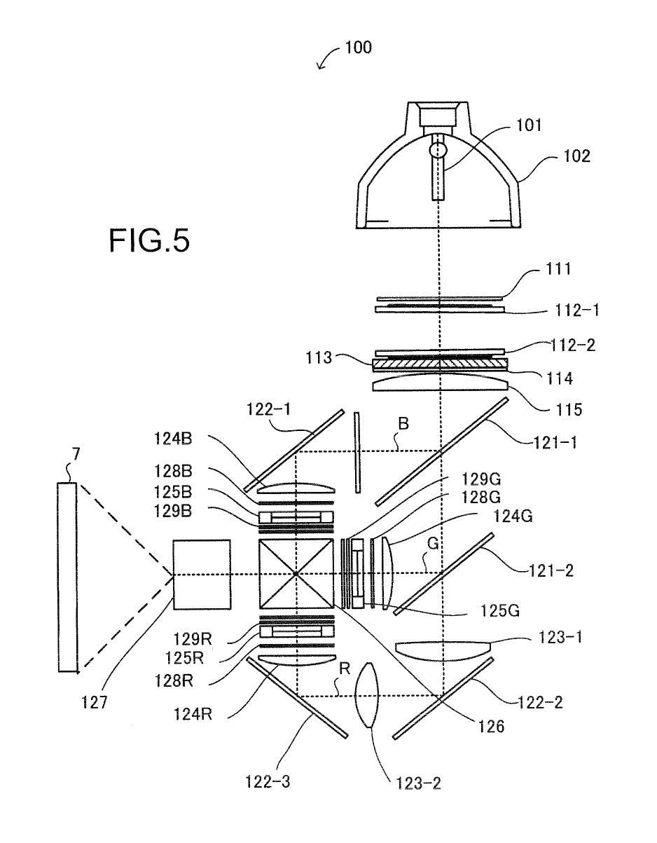

FIG. 5 is a diagram showing an exemplary optical unit configuration of a transmissive LCD projector. A transmissive LCD projector 100 includes a light source section, an illumination optical system, a separation optical system, a light modulation element section, a synthesis optical system, and a projection optical system.

The light source section includes a light source 101, and a reflector 102. The light source 101 is exemplified by an HID (High Intensity Discharge) lamp including an extra-high-pressure mercury lamp, and a metal-halide lamp. The light source 101 emits white light. The light source 101 is disposed at the focal position of the reflector 102, and generates substantially-parallel light by reflecting the white light coming from the light source 101 on the reflector 102. The reflector 102 is not restrictive to be in the parabolic shape, and may be in the elliptical shape, for example.

The illumination optical system includes a UV (Ultra Violet) cut filter 111, fly-eye lenses 112-1 and 112-2, a polarized-light separation element 113, a waveplate unit (polarized-light modulation element) 114, and a condenser lens 115.

The UV cut filter 111 is provided in front of the light source 101 to block passage of ultraviolet rays coming from the light source 101. The fly-eye lenses 112-1 and 112-2 receive the substantially-parallel light after reflection on the reflector 102, and emits the substantially-parallel light to the polarized-light separation element 113. The fly-eye lenses 112-1 and 112-2 make uniform the illuminance of light entering the light modulation element section.

The polarized-light separation element 113 separates the incoming luminous fluxes into first and second polarization components. That is, the polarized-light separation element 113 receives light being combined light of S- and P-polarized light, and emits the P-polarized light to a first region, and the S-polarized light to a second region, for example.

The waveplate unit 114 aligns the polarization axis of light coming from the polarized-light separation element 113 along a predetermined direction. That is, the waveplate unit 114 modulates the P-polarized light that has entered the first region to the S-polarized light, and aligns the polarization axis thereof along the S-polarized light that has entered the second region, for example.

The condenser lens 115 receives and gathers the light coming from the waveplate unit 114. The white light from the condenser lens 115 enters the separation optical system.

The separation optical system separates the light coming from the condenser lens Into RGB (Red, Green, and Blue) light. The separation optical system includes dichroic mirrors 121-1 and 121-2, reflection mirrors 122-1 to 122-3, relay lenses 123-1 and 123-2, and condenser lenses 124R, 124G, and 124B.

The dichroic mirrors 121-1 and 121-2 selectively transmit or reflect each of the RGB light based on the wavelength range thereof. The dichroic mirror 121-1 transmits the light G and R respectively in the green and red wavelength ranges, and reflects the light B in the blue wavelength range. The dichroic mirror 121-2 transmits the light R in the red wavelength range, and reflects the light G in the green wavelength range. With such dichroic mirrors 121-1 and 121-2, the white light is separated into light in three colors of RGB. These dichroic mirrors are available for light separation irrespective of which color, i.e., red or blue.

The reflection mirror 122-1 is a total reflection mirror, and reflects the light B in the blue wavelength range after separation by the dichroic mirror 121-1, and guides the light B to a light modulation element 125B. The reflection mirrors 122-2 and 122-3 are also each a total reflection mirror, and reflect the light R in the red wavelength range after separation by the dichroic mirror 121-2, and guide the light R to a light modulation element 125R.

The relay lenses 123-1 and 123-2 alter the optical path length for the light R in the red wavelength range. The condenser lenses 124R, 124G, and 124B converge the light R, G, and B in the red, green, and blue wavelength ranges, respectively.

The light coming from such a separation optical system, i.e., the light R, G, and B in the red, green, and blue wavelength ranges, is directed to the light modulation elements 125R, 125G, and 125B, respectively.

In front of the light modulation elements 125R, 125G, and 125B, i.e., on the light source side, incident-side polarization plates 128R, 128G, and 128B are respectively provided. These incident-side polarization plates 128R, 128G, and 128B respectively align the polarization components of the light R, G, and B in the red, green, and blue wavelength ranges provided by the separation optical system.

The light modulation elements 125R, 125G, and 125B subject, to spatial modulation, the light R, G, and B in the red, green, and blue wavelength ranges. Emission-polarization plates 129R, 129G, and 129B each transmit a predetermined polarization component of the spatially-modulated light.

The synthesis optical system includes a color synthesis prism 126. The color synthesis prism 126 transmits the light G in the green wavelength range, and reflects the light R and B respectively in the red and blue wavelength ranges toward the projection optical system.

The color synthesis prism 126 is a joint combination of a plurality of glass prisms, i.e., four isosceles right prisms substantially in the same shape, for example.

On the surfaces where the glass prisms are combined together, two interference filters having predetermined optical characteristics are formed.

The first interference filter reflects the light B in the blue wavelength range, and transmits the light R and G respectively in the red and green wavelength ranges. The second interference filter reflects the light R in the red wavelength range, and transmits the light G and B respectively in the green and blue wavelength ranges.

As such, after modulation by the light modulation elements 125R, 125G, and 125B, the resulting RGB light is combined together in the color synthesis prism 126, and then is directed to the projection optical system.

A projection lens 127 being the projection optical system magnifies the light from the color synthesis prism 126 up to a predetermined magnification for video projection on the screen 7.

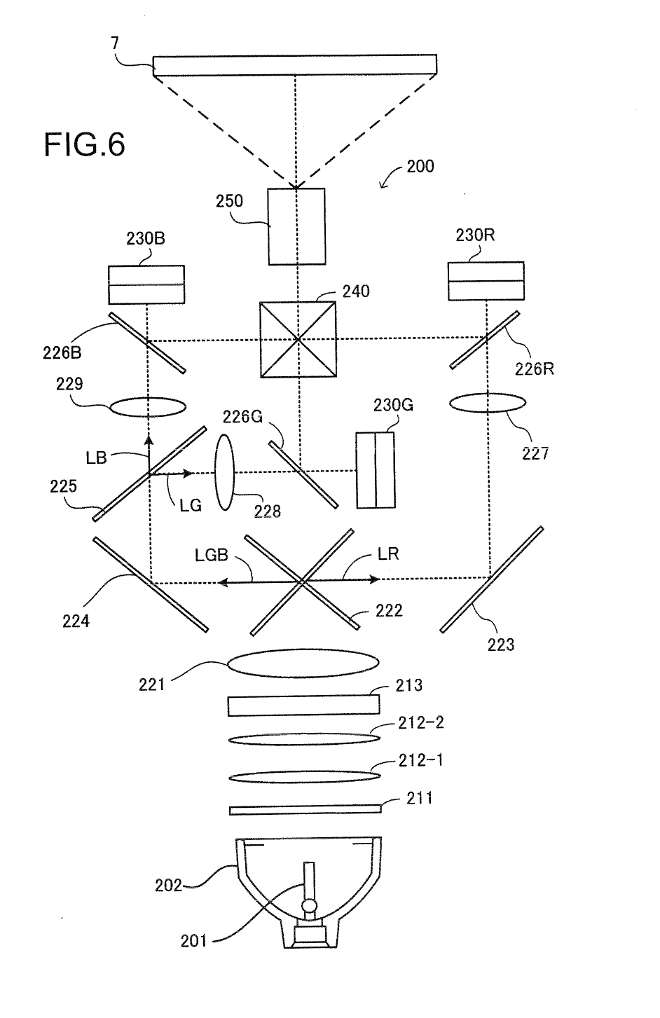

FIG. 6 is a diagram showing an exemplary optical unit configuration of a reflective LCD projector. In a reflective LCD projector 200, a light source 201 is disposed at the focal position of a reflector 202, and generates substantially-parallel light by reflecting white light coming from the light source 201 on the reflector 202. A UV/IR (Ultra Violet/Infrared Rays) cut filter 211 receives the substantially-parallel light, and blocks passage of ultraviolet rays and infrared rays. Herein, the reflector 202 is not restrictive to be in the parabolic shape, and may be in the elliptical shape, for example.

Fly-eye lenses 212-1 and 212-2 make uniform the illuminance of light, and a PS converter (polarization conversion element) 213 aligns the randomly polarized light, i.e., P-polarized light/S-polarized light, to be directed along one polarization direction. A main condenser lens 221 gathers the white illumination light whose polarization is uniformly aligned by the PS converter 213.

A dichroic mirror 222 separates the white illumination light into light LR in the red wavelength range, and light LGB in the green and blue wavelength ranges. This dichroic mirror 222 is available for light separation irrespective of which color, i.e., red or blue is separated. A reflection mirror 223 reflects the red light LR after separation by the dichroic mirror 222.

Another reflection mirror 224 reflects the green and blue light LGB after separation by the dichroic mirror 222. As for the light LGB after reflection by the reflection mirror 224, a dichroic mirror 225 reflects only the light in the green wavelength range, and transmits the remaining light in the blue wavelength range.

A polarization plate 226R transmits the red light LR, i.e., the P-polarized light, after reflection on the reflection mirror 223, and then directs the red light LR to a reflective liquid crystal panel 230R. The reflective liquid crystal panel 230R then subjects the red light LR to spatial modulation, and directs the resulting S-polarized red light to a color synthesis prism 240 by reflection. As an alternative configuration, the color synthesis prism 240 may be provided with a polarization plate on each surface where the RGB light enters.

When the color synthesis prism 240 in use is an SSS model, the green light enters the color synthesis prism 240 as it is. When the color synthesis prism 240 is an SPS model, a half waveplate is provided on the light-incident side thereof, and the green light is P-polarized and then enters the color synthesis prism 240.

A polarization plate 226G transmits the green light LG, i.e., the P-polarized light, after reflection on the dichroic mirror 225, and then directs the green light LG to a reflective liquid crystal panel 230G. The reflective liquid crystal panel 230G then subjects the green light LG to spatial modulation, and directs the resulting S-polarized green light to the color synthesis prism 240 by reflection.

A polarization plate 226B transmits the blue light LB, i.e., the P-polarized light, after transmission through the dichroic mirror 225, and then directs the blue light LB to a reflective liquid crystal panel 230B. The reflective liquid crystal panel 230B then subjects the blue light LB to spatial modulation, and directs the resulting S-polarized blue light to the color synthesis prism 240 by reflection. On the light-incident side of each of the polarization plates 226R, 226G, and 226B, optical lenses 227 to 229 are respectively provided (a polarization plate may also be provided between the optical lens 228 and the polarization plate 226G).

As for the white light coming from the light source 201, the illuminance thereof is made uniform by the fly-eye lenses 212-1 and 212-2, and the resulting light is aligned by the PS converter 213 to be directed along a predetermined polarization direction. The output light is then oriented by the main condenser lens 221 to illuminate the reflective liquid crystal panels 230R, 230G, and 230B. After being oriented as such, the light is then separated into light in three different wavelength ranges by the dichroic mirrors 222, 225, and others each serving as a color serration mirror.

After the separation, the resulting color light enters a reflective polarization plate, and only light in one specific polarization direction is selected by the polarization plates 226R, 226G, and 226B before entering the reflective liquid crystal panels 230R, 230G, and 230B. As such, the ROB light enters the reflective liquid crystal panels 230R, 230G, and 230B.

The reflective liquid crystal panels 230R, 230G, and 230B are each applied with a video signal corresponding to the color of incoming light. In accordance with the video signals, the reflective liquid crystal panels 230R, 230G, and 230B rotate the incoming light to change the polarization direction thereof. The resulting light is then modulated and output. The modulated light coming from these liquid crystal panels enters again the polarization plates 226R, 226G, and 226B.

From the polarized light in the polarization plates 226R, 226G, and 226B, only any 90-degree rotated polarized components are selected, and then are directed to the color synthesis prism 240. In the color synthesis prism 240, each color light after modulation by the three reflective liquid crystal panels is combined together to align along the same direction, and then emitted. The resulting light from the color synthesis prism 240 is then directed by the projection lens 250 for output on the screen 7.

Described next is the polarization conversion section 30 in the projection apparatus 1. The polarization conversion section 30 includes a polarization conversion element, which is any one of a wavelength-selective half waveplate, a uniaxial organic material, and a uniaxial crystal. In the below description, their characteristics are described.

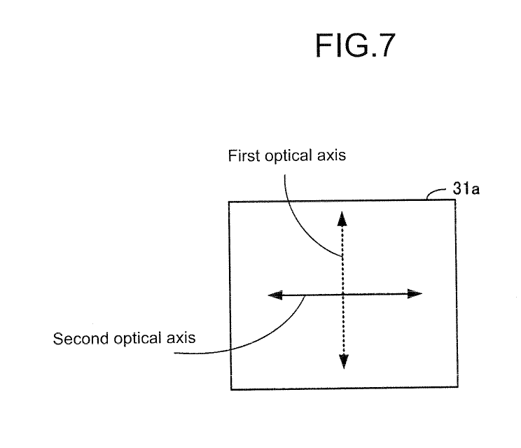

FIG. 7 is a diagram showing a wavelength-selective half waveplate. A wavelength-selective half waveplate 31a includes a first optical axis, and a second optical axis orthogonal to the first optical axis. The wavelength-selective half waveplate 31a has the characteristics of producing a phase shift of π with respect to light with a predetermined wavelength by a change of oscillation direction of the light from horizontal oscillation to vertical oscillation, and vice versa.

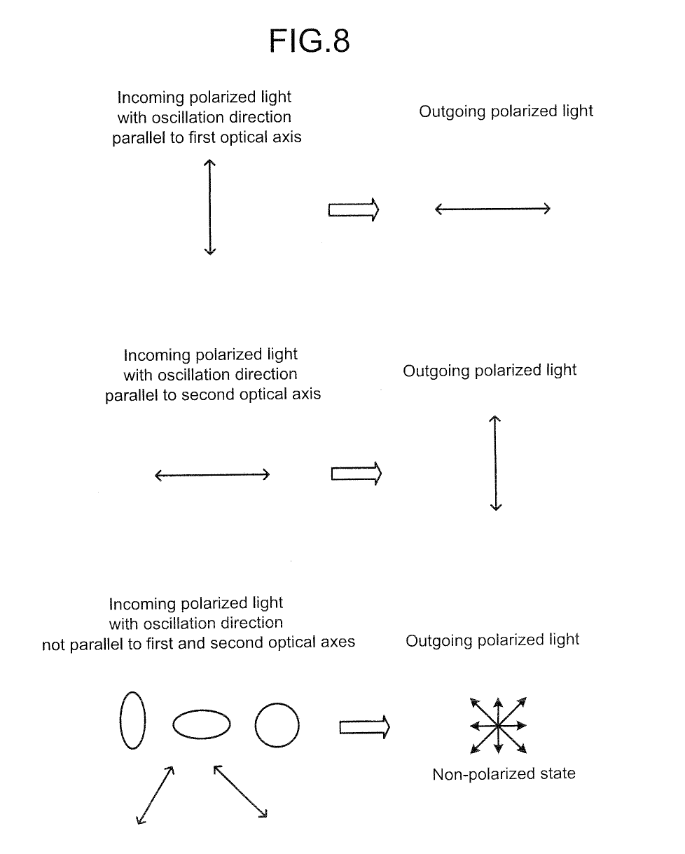

FIG. 8 is a diagram for illustrating the characteristics of the wavelength-selective half waveplate. When a linearly-polarized light beam enters the wavelength-selective half waveplate 31a with the oscillation direction thereof being parallel to the first optical axis, i.e., at the angle of 0° or π, a phase shift of it occurs, and the light beam is changed in direction to be parallel to the second optical axis and then emitted.

Conversely, when a linearly-polarized light beam enters the wavelength-selective half waveplate 31a with the oscillation direction thereof being parallel to the second optical axis, i.e., at the angle of 0° or π, a phase shift of π occurs, and the light beam is changed in direction to be parallel to the first optical axis and then emitted.

When the projection apparatus 1 uses such a wavelength-selective half waveplate 31a, instead of directing a light beam parallel to the first and second axes to the wavelength-selective half waveplate 31a, desirably, a light beam not parallel to the first and second optical axes, e.g., a linearly-polarized, circularly-polarized, or elliptically-polarized light beam is directed thereto.

That is, the light coming from the projection lens 20 becomes more like “light polarized differently on a wavelength basis” as it loses the parallel relationship with the first and second optical axes of the wavelength-selective half waveplate 31a, and the light is put in the non-polarized state.

As such, by passing through the wavelength-selective half waveplate 31a, the light coming from the projection lens 20, i.e., the light whose oscillation direction is not parallel to the first and second optical axes, is polarized differently on a wavelength basis by the wavelength-selective half waveplate 31a, and is put in the non-polarized state.

When the projection lens 20 in use is a plastic lens that greatly affects the polarization patterns of light, the wavelength-selective half waveplate 31a may be used in combination with a quarter waveplate, whose optical axis forms an angle of 135° against any incoming polarized light.

That is, with a quarter waveplate disposed on the light-incident side of the wavelength-selective half waveplate 31a, for example, the polarization state of light becomes more like non-polarized state because the polarized light that is not parallel in oscillation direction with respect to the first and second optical axes of the wavelength-selective half waveplate 31a is directed to the wavelength-selective half waveplate 31a.

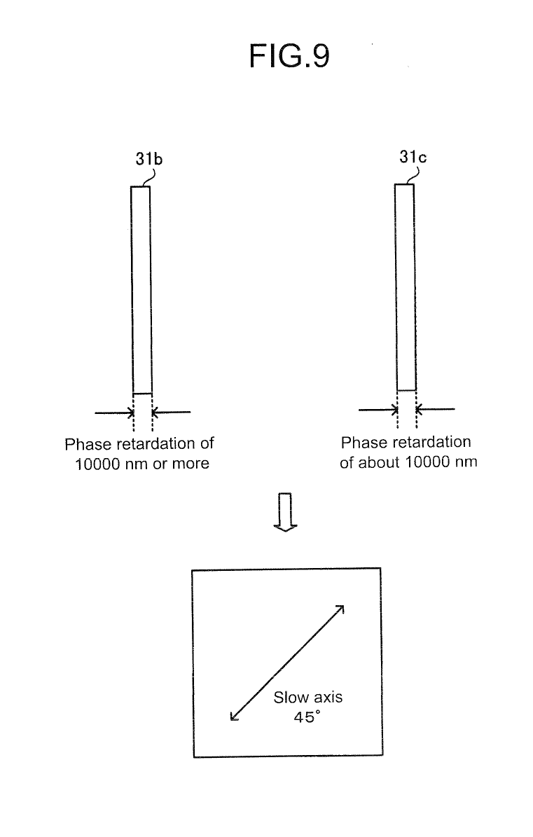

FIG. 9 is a diagram showing a uniaxial organic material and a uniaxial crystal. A uniaxial organic material 31b is an organic material having one optical axis, and is exemplified by a large-phase retardation plate. Such a uniaxial organic material 31b causes phase retardation of 10000 nm or more to light entering thereto.

The uniaxial crystal 31c is a crystal having one optical axis, and is exemplified by quartz crystal (quartz), sapphire, calcite, and magnesium fluoride. Such a uniaxial crystal 31c causes phase retardation of about 10000 nm to light entering thereto (about 1 mm with quartz). The uniaxial organic material 31b and the uniaxial crystal 31c each have a slow axis at an angle of 45°.

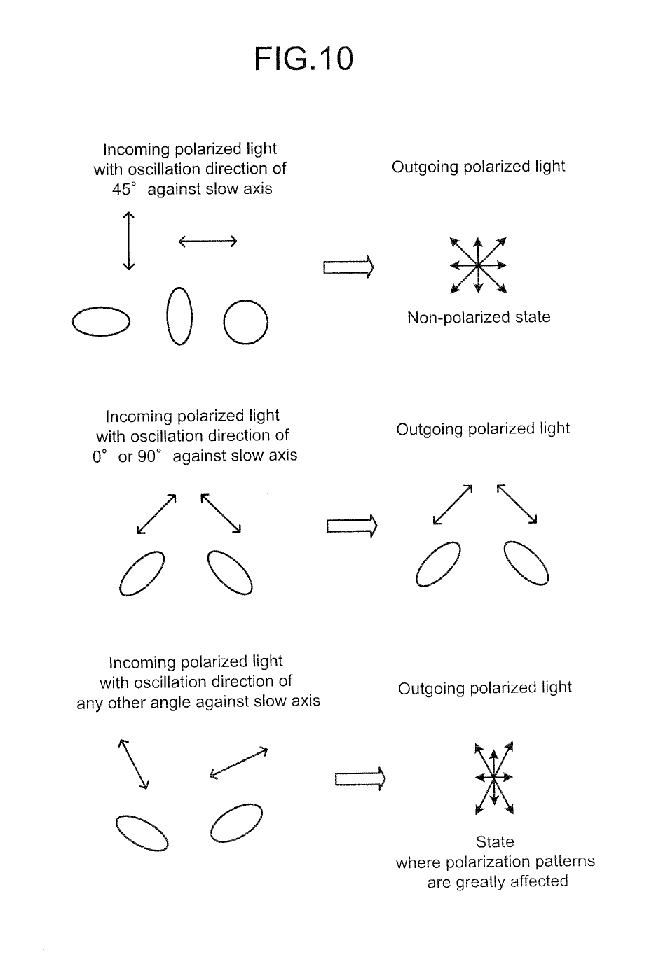

FIG. 10 is a diagram for illustrating the characteristics of the uniaxial organic material, and those of the uniaxial crystal. With the characteristics of the uniaxial organic material 31b, and with those of the uniaxial crystal 31c, the index of refraction affects more on incoming light whose oscillation direction is the same as the slow axis of FIG. 10, but affects less on incoming light whose oscillation direction is different from the slow axis.

As such, when incoming polarized light oscillates (rotates) in the direction of 45° against the slow axis, the outgoing light is in the non-polarized state. When the incoming polarized light oscillates in the direction of 0° or 90° against the slow axis, the outgoing light shows no change as the phase of the incoming polarized light.

On the other hand, when the incoming polarized light oscillates in any other direction with respect to the slow axis, the outgoing polarized light has the polarization patterns greatly affected thereby, and thus the state thereof is not even close to the non-polarized state.

When the projection apparatus 1 uses the uniaxial organic material 31b or the uniaxial crystal 31c, desirably, a light beam directed thereto is a linearly-polarized, circularly-polarized, or elliptically-polarized light beam oscillating in the direction of 45° against the slow axis.

That is, the light coming from the projection lens 20 is polarized with an oscillation direction of 45° against the slow axis of the uniaxial organic material 31b or that of the uniaxial crystal 31c. Such polarized light is directed to the uniaxial organic material 31b or the uniaxial crystal 31c.

As such, by passing through the uniaxial organic material 31b or the uniaxial crystal 31c, the light coming from the projection lens 20, i.e., the polarized light whose oscillation direction is at an angle of 45° against the slow axis, is polarized differently on a wavelength basis by the uniaxial organic material 31b or the uniaxial crystal 31c, and is put in the non-polarized state.

Herein, as the polarization conversion element to be provided in front of the projection lens 20, the wavelength-selective half waveplate 31a produces greater effects than the uniaxial organic material 31b and the uniaxial crystal 31c. This is because, although the uniaxial organic material 31b and the uniaxial crystal 31c indeed serve best when incoming light is polarized with an oscillation direction of 45° against the slow axis, the polarized light is not always with an oscillation direction of 45° in front of the projection lens 20.

However, the uniaxial organic material 31b and the uniaxial crystal 31c serve well enough when the projection lens 20 does not affect that much the polarization patterns of light, e.g., when the projection lens 20 is a glass lens, and are both less expensive than the wavelength-selective half waveplate.

Note that described above are the characteristics of each of the wavelength-selective half waveplate 31a, the uniaxial organic material 31b, and the uniaxial crystal 31c serving as a polarization conversion element, but alternatively, any other optical member may be used as long as it has the characteristics of polarizing light differently on a wavelength basis.

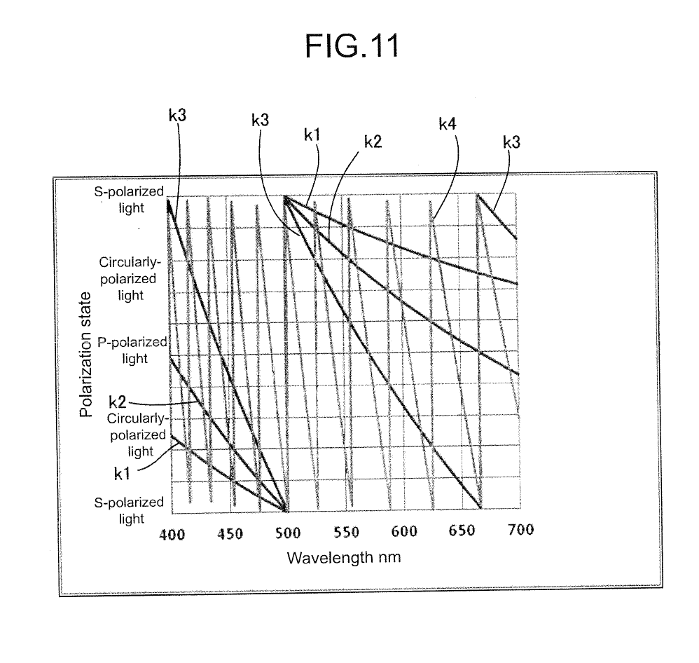

Described next is the polarization state of light affected by phase retardation of the uniaxial organic material 31b and that of the uniaxial crystal 31c. FIG. 11 is a diagram showing the polarization state of light affected by phase retardation of the uniaxial organic material and that of the uniaxial crystal. The vertical axis indicates the polarization state of light, and the horizontal axis indicates the wavelength (nm). In FIG. 11, a curve k1 is with phase retardation of 500 nm, a curve k2 is with phase retardation of 1000 nm, a curve k3 is with phase retardation of 2000 nm, and a curve k4 (jagged line) is with phase retardation of 10000 nm.

Exemplified herein is a case where the phase retardation is large, e.g., 10000 nm, with the slow axis of 45° against incoming linearly-polarized light, which corresponds to the jagged line in the drawing. Assuming that linearly-polarized light with a certain wavelength, e.g., 550 nm, passes through the slow axis, light with an adjacent wavelength, e.g., 501 nm, is polarized elliptically (almost linearly).

As such, mixing the light polarized differently in the wavelength range in use (about 430 to 700 nm) produces light polarized differently on a wavelength basis so that the non-polarized state is created.

Accordingly, when the polarization conversion element in use is the uniaxial organic material 31b and the uniaxial crystal 31c, if the conditions are satisfied, i.e., the slow axis is at an angle of 45° and the phase retardation is large, the light is largely polarized with a change of wavelength so that the light becomes more uniform in the resulting non-polarized state.

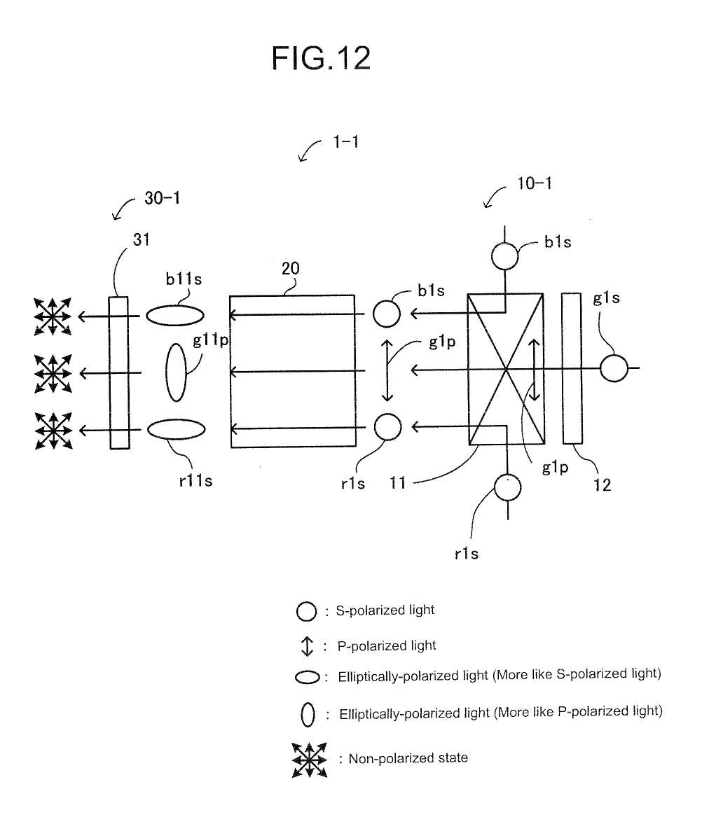

By referring to FIGS. 12 to 19, described next are various manners to perform the polarization conversion process in the projection apparatus 1, i.e., various placement patterns of optical members. FIG. 12 is a diagram showing an exemplary configuration of a projection apparatus. A projection apparatus 1-1 includes a color synthesis section 10-1, the projection lens 20, and a polarization conversion section 30-1.

The color synthesis section 10-1 includes a color synthesis prism 11, and a half waveplate 12. The polarization conversion section 30-1 includes a polarization conversion element 31. The polarization conversion element 31 uses any of the wavelength-selective half waveplate 31a, the uniaxial organic material 31b, and the uniaxial crystal 31c described above by referring to FIGS. 7 to 11.

The half waveplate 12 is disposed on the side of the SPS-model color synthesis prism 11 where green light enters. The half waveplate 12 performs polarization conversion on S-polarized green light g1s so that green P-polarized light g1p is generated. Herein, the half waveplate generally basically functions to produce optical-path retardation of a half wavelength (phase retardation δ=180°+N×360°) between two linear polarized light (transverse and vertical components) when light basses therethrough. The half waveplate is used mainly for rotating the plane of polarization at a predetermined angle (N=1, 2, 3, and others).

The color synthesis prism 11 generates light being combined light of red S-polarized light r1s, the green P-polarized light g1p, and blue S-polarized light b1s. The red S-polarized light r1s is S-polarized red light, and the blue S-polarized light b1s is S-polarized blue light.

The projection lens 20 receives the combined light, and then magnifies the combined light up to a predetermined magnification for emission. At this time, by passing through the projection lens 20, the red S-polarized light r1s in the combined light is converted into red elliptically-polarized light r11s (elliptically-polarized light more like S-polarized light).

Further, by passing through the projection lens 20, the green P-polarized light g1p in the combined light is converted into green elliptically-polarized light g11p (elliptically-polarized light more like P-polarized light). Still further, by passing through the projection lens 20, the blue S-polarized light b1s in the combined light is converted into blue elliptically-polarized light b11s (elliptically-polarized light more like S-polarized light).

The polarization conversion element 31 puts, in the non-polarized state, the light coming from the projection lens 20, i.e., the red elliptically-polarized light r11s, the green elliptically-polarized light g11p, and the blue elliptically-polarized light b11s. Thereafter, the light put in the non-polarized state is directed onto a screen.

With the projection apparatus 1-1 configured as above, the light directed to the screen and the light reflected thereon is in the non-polarized state. This accordingly considerably improves the quality of 3D images with color unevenness made less conspicuous when 3D glasses are not tilted, and with color unevenness made less conspicuous and brightness made less reduced when the 3D glasses are tilted.

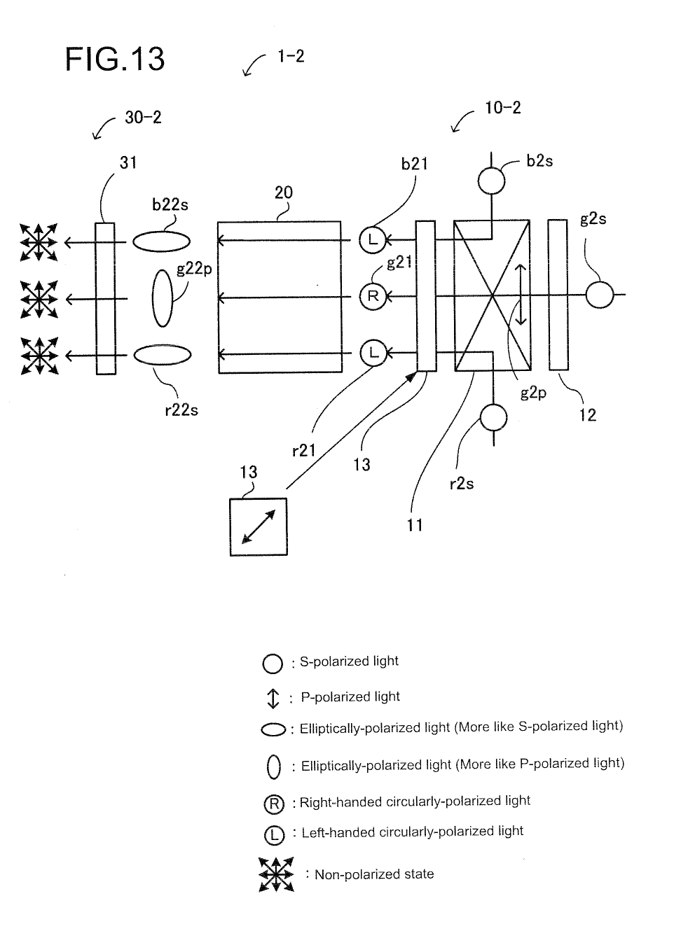

FIG. 13 is a diagram showing an exemplary configuration of a projection apparatus. A projection apparatus 1-2 includes a color synthesis section 10-2, the projection lens 20, and a polarization conversion section 30-2.

The color synthesis section 10-2 includes the color synthesis prism 11, the half waveplate 12, and a quarter waveplate 13. The polarization conversion section 30-2 includes the polarization conversion element 31. The polarization conversion element 31 uses any of the wavelength-selective half waveplate 31a, the uniaxial organic material 31b, and the uniaxial crystal 31c described above by referring to FIGS. 7 to 11.

The half waveplate 12 is disposed on the side of the SPS-model color synthesis prism 11 where green light enters. The half waveplate 12 performs polarization conversion on S-polarized green light g2s so that green P-polarized light g2p is generated. The color synthesis prism 11 generates light being combined light of red S-polarized light r2s, the green P-polarized light g2p, and blue S-polarized light b2s. The red S-polarized light r2s is S-polarized red light, and the blue S-polarized light b2s is S-polarized blue light.

The quarter waveplate 13 is disposed on the light emission side of the color synthesis prism 11, and is so oriented that the optical axis forms an angle of 45° against incoming polarized light. The quarter waveplate 13 converts the red S-polarized light r2s into left-handed circularly-polarized light, i.e., red left-handed circularly-polarized light r21, the green P-polarized light g2p into right-handed circularly-polarized light, i.e., green right-handed circularly-polarized light g21, and the blue S-polarized light b2s into left-handed circularly-polarized light, i.e., blue left-handed circularly-polarized light b21.

Herein, the quarter waveplate generally basically functions to produce optical-path retardation of a quarter wavelength (phase retardation δ=90°+N×360°) between two linear polarized light (transverse and vertical components) when light passes therethrough. The quarter waveplate is used mainly for converting linearly-polarized light into circularly-polarized light, or conversely, converting circularly-polarized light into linearly-polarized light (N=1, 2, 3, and others).

The concern here is that, when light from the color synthesis prism 11 enters the projection lens 20, the light reflected on the projection lens 20 may return back to the color synthesis prism. If this is the case, this may generate stray light, and may cause a ghost phenomenon or others on the screen. Therefore, in the embodiment of the present technology, the quarter waveplate 13 as described above is provided for prevention of stray light between the light-emission stage of the color synthesis prism 11 and the light-incident stage of the projection lens 20.

The projection lens 20 receives the combined light, and then magnifies the combined light up to a predetermined magnification for emission. At this time, by passing through the projection lens 20, the red left-handed circularly-polarized light r21 in the combined light is converted into red elliptically-polarized light r22s (elliptically-polarized light more like S-polarized light).

Further, by passing through the projection lens 20, the green right-handed circularly-polarized light g21 in the combined light is converted into green elliptically-polarized light g22p (elliptically-polarized light more like P-polarized light). Still further, by passing through the projection lens 20, the blue left-handed circularly-polarized light b21 in the combined light is converted into blue elliptically-polarized light b22s (elliptically-polarized light more like S-polarized light).

The polarization conversion element 31 puts, in the non-polarized state, the light coming from the projection lens 20, i.e., the red elliptically-polarized light r22s, the green elliptically-polarized light g22p, and the blue elliptically-polarized light b22s. Thereafter, the light put in the non-polarized state is directed onto a screen.

With the projection apparatus 1-2 configured as above, the light directed to the screen and the light reflected thereon is in the non-polarized state. This accordingly considerably improves the quality of 3D images with color unevenness made less conspicuous when 3D glasses are not tilted, and with color unevenness made less conspicuous and brightness made less reduced when the 3D glasses are tilted.

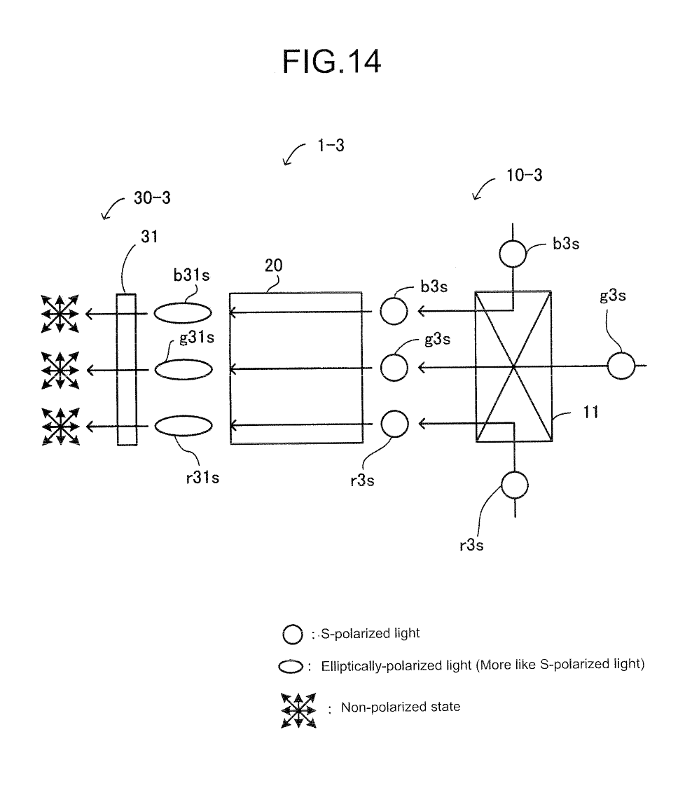

FIG. 14 is a diagram showing an exemplary configuration of a projection apparatus. A projection apparatus 1-3 includes a color synthesis section 10-3, the projection lens 20, and a polarization conversion section 30-3.

The polarization conversion section 30-3 includes the polarization conversion element 31. The polarization conversion element 31 uses any of the wavelength-selective half waveplate 31a, the uniaxial organic material 31b, and the uniaxial crystal 31c described above by referring to FIGS. 7 to 11.

The SSS-model color synthesis prism 11 generates light being combined light of red S-polarized light r3s, green S-polarized light g3s, and blue S-polarized light b3s. The red S-polarized light r3s is S-polarized red light, the green S-polarized light g3s is S-polarized green light, and the blue S-polarized light b3s is S-polarized blue light.

The projection lens 20 receives the combined light, and then magnifies the combined light up to a predetermined magnification for emission. At this time, by passing through the projection lens 20, the red S-polarized light r3s in the combined light is converted into red elliptically-polarized light r31s (elliptically-polarized light more like S-polarized light).

Further, by passing through the projection lens 20, the green S-polarized light g3s in the combined light is converted into green elliptically-polarized light g31s (elliptically-polarized light more like S-polarized light). Still further, by passing through the projection lens 20, the blue S-polarized light b3s in the combined light is converted into blue elliptically-polarized light b31s (elliptically-polarized light more like S-polarized light).

The polarization conversion element 31 puts, in the non-polarized state, the light coming from the projection lens 20, i.e., the red elliptically-polarized light r31s, the green elliptically-polarized light g31s, and the blue elliptically-polarized light b31s. Thereafter, the light put in the non-polarized state is directed onto a screen.

With the projection apparatus 1-3 configured as above, the light directed to the screen and the light reflected thereon is in the non-polarized state. This accordingly considerably improves the quality of 3D images with color unevenness made less conspicuous when 3D glasses are not tilted, and with color unevenness made less conspicuous and brightness made less reduced when the 3D glasses are tilted.

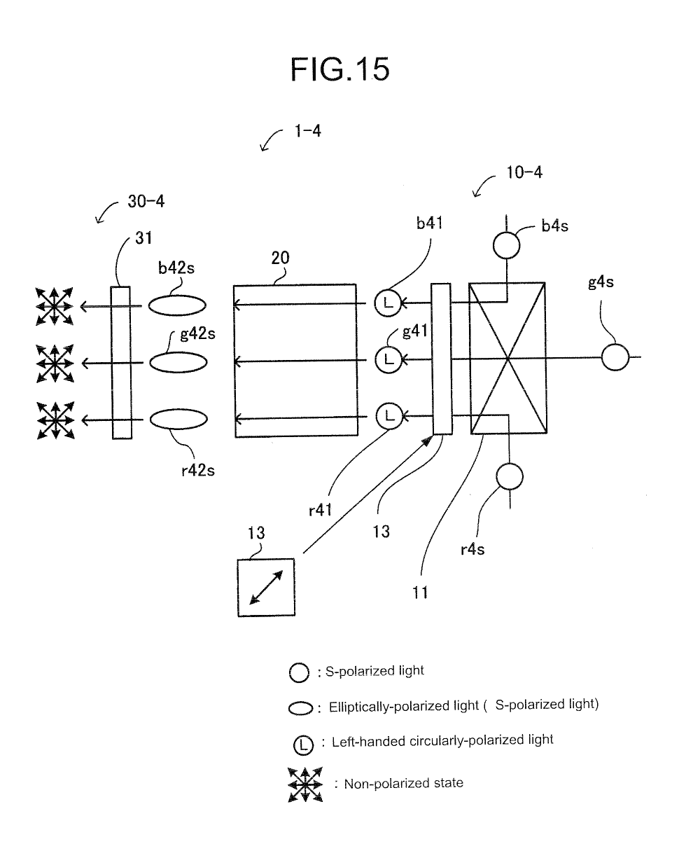

FIG. 15 is a diagram showing an exemplary configuration of a projection apparatus. A projection apparatus 1-4 includes a color synthesis section 10-4, the projection lens 20, and a polarization conversion section 30-4.

The color synthesis section 10-4 includes the color synthesis prism 11, and the quarter waveplate 13. The polarization conversion section 30-4 includes the polarization conversion element 31. The polarization conversion element 31 uses any of the wavelength-selective half waveplate 31a, the uniaxial organic material 31b, and the uniaxial crystal 31c described above by referring to FIGS. 7 to 11.

The SSS-model color synthesis prism 11 generates light being combined light of red S-polarized light r4s, green S-polarized light g4s, and blue S-polarized light b4s. The red S-polarized light r4s is S-polarized red light, the green S-polarized light g4s is S-polarized green light, and the blue S-polarized light b4s is S-polarized blue light.

For prevention of the stray light described above, the quarter waveplate 13 is disposed on the light-emission side of the color synthesis prism 11, and is so oriented that the optical axis forms an angle of 45° against incoming polarized light. The quarter waveplate 13 converts the red S-polarized light r4s into left-handed circularly-polarized light, i.e., red left-handed circularly-polarized light r41, the green S-polarized light g4s into left-handed circularly-polarized light, green left-handed circularly-polarized light g41, and the blue S-polarized light b4s into left-handed circularly-polarized light, i.e., blue left-handed circularly-polarized light b41.

The projection lens 20 receives the combined light, and then magnifies the combined light up to a predetermined magnification for emission. At this time, by passing through the projection lens 20, the red left-handed circularly-polarized light r41 in the combined light is converted into red elliptically-polarized light r42s (elliptically-polarized light more like S-polarized light).

Further, by passing through the projection lens 20, the green left-handed circularly-polarized light g41 in the combined light is converted into green elliptically-polarized light g42s (elliptically-polarized light more like S-polarized light). Still further, by passing through the projection lens 20, the blue left-handed circularly-polarized light b41 in the combined light is converted into blue elliptically-polarized light b42s (elliptically-polarized light more like S-polarized light).

The polarization conversion element 31 puts, in the non-polarized state, the light coming from the projection lens 20, i.e., the red elliptically-polarized light r42s, the green elliptically-polarized light g42s, and the blue elliptically-polarized light b42s. Thereafter, the light put in the non-polarized state is directed onto a screen.

With the projection apparatus 1-4 configured as above, the light directed to the screen and the light reflected thereon is in the non-polarized state. This accordingly considerably improves the quality of 3D images with color unevenness made less conspicuous when 3D glasses are not tilted, and with color unevenness made less conspicuous and brightness made less reduced when the 3D glasses are tilted.

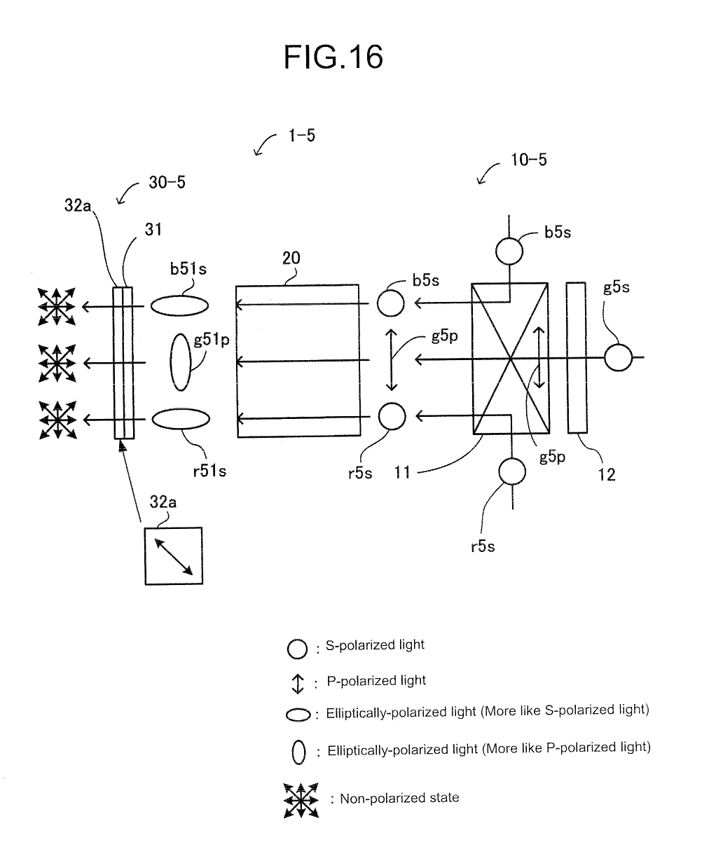

FIG. 16 is a diagram showing an exemplary configuration of a projection apparatus. A projection apparatus 1-5 includes a color synthesis section 10-5, the projection lens 20, and a polarization conversion section 30-5.

The color synthesis section 10-5 includes the color synthesis prism 11, and the half waveplate 12. The polarization conversion section 30-5 includes the polarization conversion element 31, and a quarter waveplate 32a. The polarization conversion element 31 uses any of the wavelength-selective half waveplate 31a, the uniaxial organic material 31b, and the uniaxial crystal 31c described above by referring to FIGS. 7 to 11.

The half waveplate 12 is disposed on the side of the SPS-model color synthesis prism 11 where green light enters. The half waveplate 12 performs P-polarization conversion on S-polarized green light g5s so that green P-polarized light g5p is generated. The color synthesis prism 11 generates light being combined light of red S-polarized light r5s, the green P-polarized light g5p, and blue S-polarized light b5s. The red S-polarized light r5s is S-polarized red light, and the blue S-polarized light b5s is S-polarized blue light.

The projection lens 20 receives the combined light, and then magnifies the combined light up to a predetermined magnification for emission. At this time, by passing through the projection lens 20, the red S-polarized light r5s in the combined light is converted into red elliptically-polarized light r51s (elliptically-polarized light more like S-polarized light).

By passing through the projection lens 20, the green P-polarized light g5p in the combined light is converted into green elliptically-polarized light g51p (elliptically-polarized light more like P-polarized light). Still further, by passing through the projection lens 20, the blue S-polarized light b5s in the combined light is converted into blue elliptically-polarized light b51s (elliptically-polarized light more like S-polarized light).

The polarization conversion element 31 puts, in the non-polarized state, the light coming from the projection lens 20, i.e., the red elliptically-polarized light r51s, the green elliptically-polarized light g51p, and the blue elliptically-polarized light b51s.

Alternatively, depending on how the projection lens 20 affects the polarization patterns of light, the quarter waveplate 32a may be provided on the light-emission stage of the polarization conversion element 31 with the optical axis oriented in the direction of 135° against incoming polarized light. With the quarter waveplate 32a provided as such, the light is put in the better non-polarized state, and this makes color unevenness less conspicuous and brightness less reduced.

With the projection apparatus 1-5 configured as above, the light directed to the screen and the light reflected thereon is in the non-polarized state. This accordingly considerably improves the quality of 3D images with color unevenness made less conspicuous when 3D glasses are not tilted, and with color unevenness made less conspicuous and brightness made less reduced when the 3D glasses are tilted.

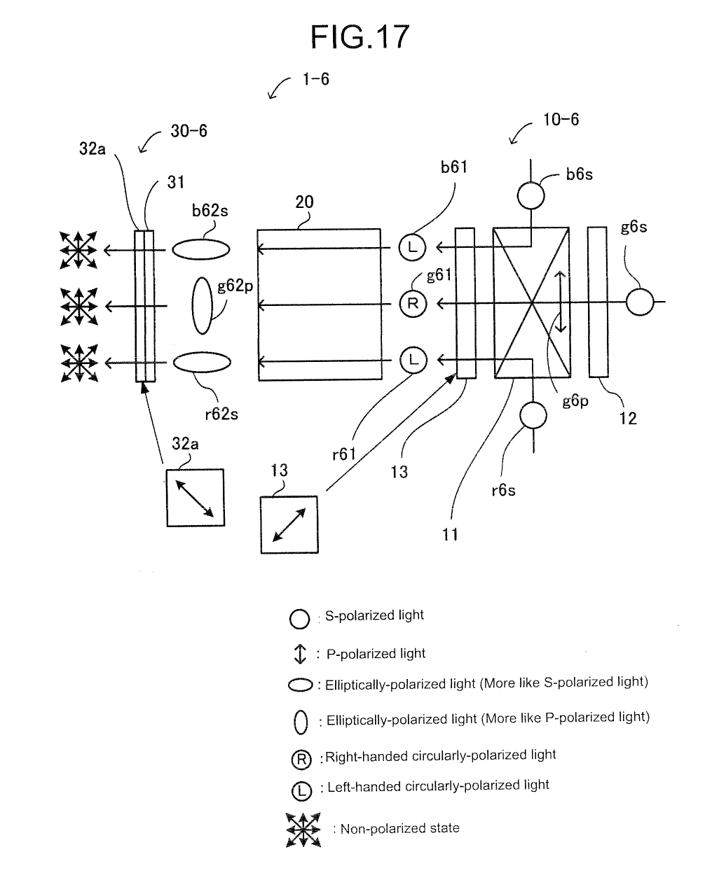

FIG. 17 is a diagram showing an exemplary configuration of a projection apparatus. A projection apparatus 1-6 includes a color synthesis section 10-6, the projection lens 20, and a polarization conversion section 30-6.

The color synthesis section 10-6 includes the color synthesis prism 11, the half waveplate 12, and the quarter waveplate 13. The polarization conversion section 30-6 includes the polarization conversion element 31, and the quarter waveplate 32a. The polarization conversion element 31 uses any of the wavelength-selective half waveplate 31a, the uniaxial organic material 31b, and the uniaxial crystal 31c described above by referring to FIGS. 7 to 11.

The half waveplate 12 is disposed on the side of the SPS-model color synthesis prism 11 where green light enters. The half waveplate 12 performs polarization conversion on S-polarized green light g6s so that green P-polarized light g6p is generated. The color synthesis prism 11 generates light being combined light of red S-polarized light r6s, the green P-polarized light g6p, and blue S-polarized light b6s. The red S-polarized light r6s is S-polarized red light, and the blue S-polarized light b6s is S-polarized blue light.

For prevention of the stray light described above, the quarter waveplate 13 is disposed on the light-emission side of the color synthesis prism 11, and is so oriented that the optical axis forms an angle of 45° against incoming polarized light. The quarter waveplate 13 converts the red S-polarized light r6s into left-handed circularly-polarized light, i.e., red left-handed circularly-polarized light r61, the green P-polarized light g6p into right-handed circularly-polarized light, i.e., green right-handed circularly-polarized light g61, and the blue S-polarized light b6s into left-handed circularly-polarized light, i.e., blue left-handed circularly-polarized light b61.

The projection lens 20 receives the combined light, and then magnifies the combined light up to a predetermined magnification for emission. At this time, by passing through the projection lens 20, the red left-handed circularly-polarized light r61 in the combined light is converted into red elliptically-polarized light r62s (elliptically-polarized light more like S-polarized light).

Further, by passing through the projection lens 20, the green right-handed circularly-polarized light g61 in the combined light is converted into green elliptically-polarized light g62p (elliptically-polarized light more like P-polarized light). Still further, by passing through the projection lens 20, the blue left-handed circularly-polarized light b61 in the combined light is converted into blue elliptically-polarized light b62s (elliptically-polarized light more like S-polarized light).

The polarization conversion element 31 puts, in the non-polarized state, the light coming from the projection lens 20, i.e., the red elliptically-polarized light r62s, the green elliptically-polarized light g62p, and the blue elliptically-polarized light b62s.

Alternatively, depending on how the projection lens 20 affects the polarization patterns of light, the quarter waveplate 32a may be provided on the light-emission stage of the polarization conversion element 31 with the optical axis oriented in the direction of 135° against incoming polarized light. With the quarter waveplate 32a provided as such, the light is put in the better non-polarized state, and this makes color unevenness less conspicuous and brightness less reduced.

With the projection apparatus 1-6 configured as above, the light directed to the screen and the light reflected thereon is in the non-polarized state. This accordingly considerably improves the quality of 3D images with color unevenness made less conspicuous when 3D glasses are not tilted, and with color unevenness made less conspicuous and brightness made less reduced when the 3D glasses are tilted.

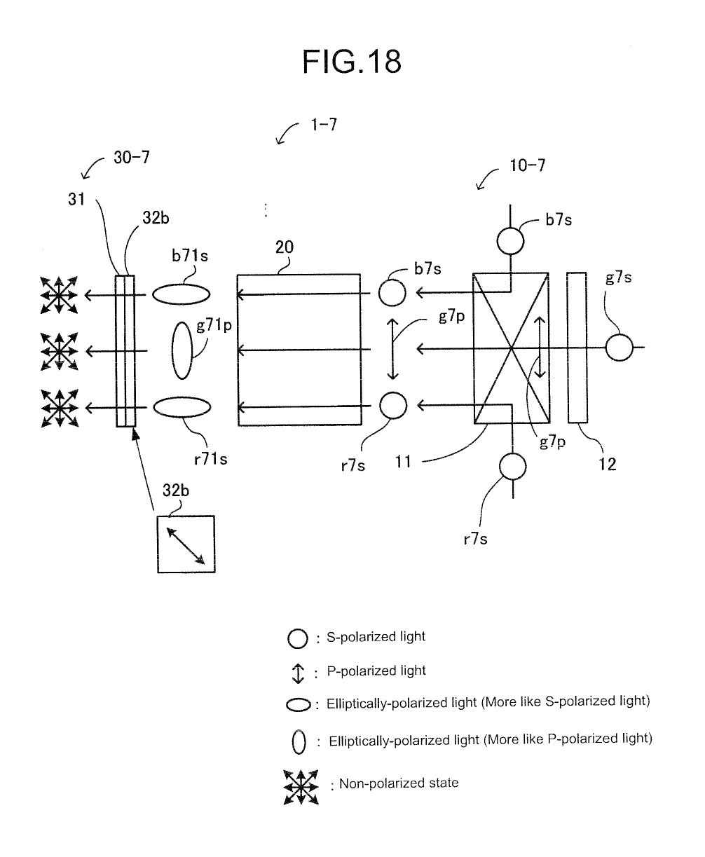

FIG. 18 is a diagram showing an exemplary configuration of a projection apparatus. A projection apparatus 1-7 includes a color synthesis section 10-7, the projection lens 20, and a polarization conversion section 30-7.

The color synthesis section 10-7 includes the color synthesis prism 11, and the half waveplate 12. The polarization conversion section 30-7 includes the polarization conversion element 31, and a quarter waveplate 32b. The polarization conversion element 31 uses any of the wavelength-selective half waveplate 31a, the uniaxial organic material 31b, and the uniaxial crystal 31c described above by referring to FIGS. 7 to 11.

The half waveplate 12 is disposed on the side of the SPS-model color synthesis prism 11 where green light enters. The half waveplate 12 performs polarization conversion on S-polarized green light g7s so that green P-polarized light g7p is generated. The color synthesis prism 11 generates light being combined light of red S-polarized light r7s, the green P-polarized light g7p, and blue S-polarized light b7s. The red S-polarized light r7s is S-polarized red light, and the blue S-polarized light b7s is S-polarized blue light.

The projection lens 20 receives the combined light, and then magnifies the combined light up to a predetermined magnification for emission. At this time, by passing through the projection lens 20, the red S-polarized light r7s in the combined light is converted into red elliptically-polarized light r71s (elliptically-polarized light more like S-polarized light).

Further, by passing through the projection lens 20, the green P-polarized light g7p in the combined light is converted into green elliptically-polarized light g71p (elliptically-polarized light more like P-polarized light). Still further, by passing through the projection lens 20, the blue S-polarized light b7s in the combined light is converted into blue elliptically-polarized light b71s (elliptically-polarized light more like S-polarized light).

The polarization conversion element 31 puts, in the non-polarized state, the light coming from the projection lens 20, i.e., the red elliptically-polarized light r71s, the green elliptically-polarized light g71p, and the blue elliptically-polarized light b71s.

Alternatively, depending on how the projection lens 20 affects the polarization patterns of light, the quarter waveplate 32b may be provided between the light-emission side of the projection lens 20 and the light-incident side of the polarization conversion element 31 with the optical axis oriented in the direction of 135° against incoming polarized light. With the quarter waveplate 32b provided as such, the light is put in the better non-polarized state, and this makes color unevenness less conspicuous and brightness less reduced.

With the projection apparatus 1-7 configured as above, the light directed to the screen and the light reflected thereon is in the non-polarized state. This accordingly considerably improves the quality of 3D images with color unevenness made less conspicuous when 3D glasses are not tilted, and with color unevenness made less conspicuous and brightness made less reduced when the 3D glasses are tilted.

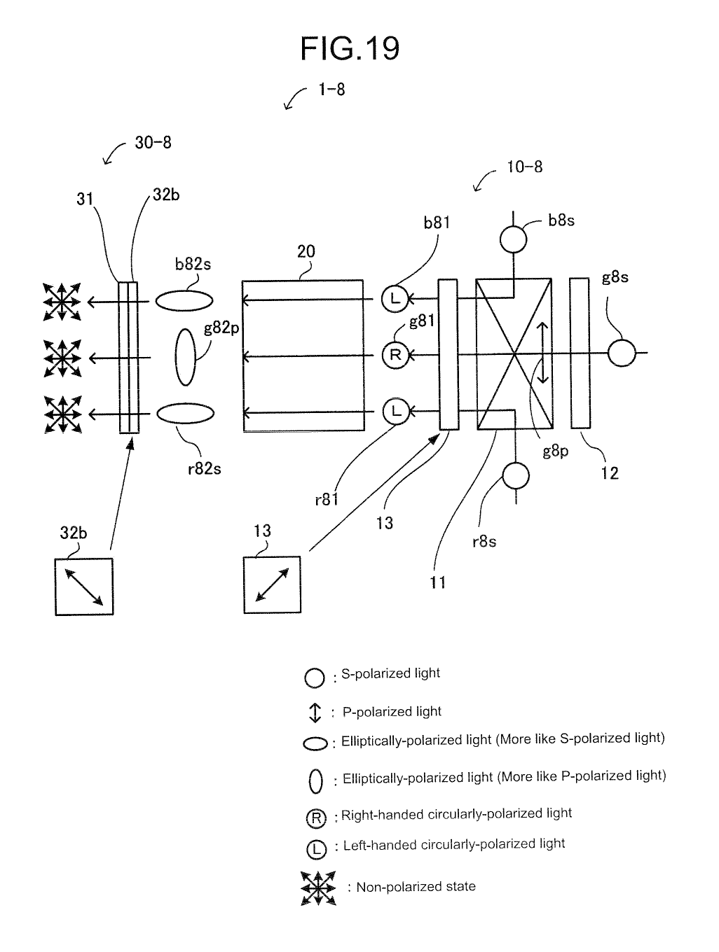

FIG. 19 is a diagram showing an exemplary configuration of a projection apparatus. A projection apparatus 1-8 includes a color synthesis section 10-8, the projection lens 20, and a polarization conversion section 30-8.

The color synthesis section 10-8 includes the color synthesis prism 11, the half waveplate 12, and the quarter waveplate 13. The polarization conversion section 30-8 includes the polarization conversion element 31, and the quarter waveplate 32b. The polarization conversion element 31 uses any of the wavelength-selective half waveplate 31a, the uniaxial organic material 31b, and the uniaxial crystal 31c described above by referring to FIGS. 7 to 11.

The half waveplate 12 is disposed on the side of the SPS-model color synthesis prism 11 where green light enters. The half waveplate 12 performs polarization conversion on S-polarized green light g8s so that green P-polarized light g8p is generated. The color synthesis prism 11 generates light being combined light of red S-polarized light r8s, the green P-polarized light g8p, and blue S-polarized light b8s. The red S-polarized light r8s is S-polarized red light, and the blue S-polarized light b8s is S-polarized blue light.

For prevention of the stray light described above, the quarter waveplate 13 is disposed on the light-emission side of the color synthesis prism 11, and is so oriented that the optical axis forms an angle of 45° against incoming polarized light. The quarter waveplate 13 converts the red S-polarized light r8s into left-handed circularly-polarized light, i.e., red left-handed circularly-polarized light r81, the green P-polarized light g8p into right-handed circularly-polarized light, i.e., green right-handed circularly-polarized light g81, and the blue S-polarized light b8s into left-handed circularly-polarized light, i.e., blue left-handed circularly-polarized light b81.

The projection lens 20 receives the combined light, and then magnifies the combined light up to a predetermined magnification for emission. At this time, by passing through the projection lens 20, the red left-handed circularly-polarized light r81 in the combined light is converted into red elliptically-polarized light r82s (elliptically-polarized light more like S-polarized light).

Further, by passing through the projection lens 20, the green right-handed circularly-polarized light g81 in the combined light is converted into green elliptically-polarized light g82p (elliptically-polarized light more like P-polarized light). Still further, by passing through the projection lens 20, the blue left-handed circularly-polarized light b81 in the combined light is converted into blue elliptically-polarized light b82s (elliptically-polarized light more like S-polarized light).

The polarization conversion element 31 puts, in the non-polarized state, the light coming from the projection lens 20, i.e., the red elliptically-polarized light r82s, the green elliptically-polarized light g82p, and the blue elliptically-polarized light b82s.

Alternatively, depending on how the projection lens 20 affects the polarization patterns of light, the quarter waveplate 32b may be provided between the light-emission side of the projection lens 20 and the light-incident side of the polarization conversion element 31 with the optical axis oriented in the direction of 135° against incoming polarized light. With the quarter waveplate 32b provided as such, the light is put in the better non-polarized state, and this makes color unevenness less conspicuous and brightness less reduced.

With the projection apparatus 1-8 configured as above, the light directed to the screen and the light reflected thereon is in the non-polarized state. This accordingly considerably improves the quality of 3D images with color unevenness made less conspicuous when 3D glasses are not tilted, and with color unevenness made less conspicuous and brightness made less reduced when the 3D glasses are tilted.

Herein, the projection apparatus 1-8 of FIG. 19 is in the optimum optical state. With the optical state as the projection apparatus 1-8, a plastic lens may be used for the projection lens 20 (a plastic lens greatly affecting the polarization patterns of light is also possible).

With the use of the SPS-model color synthesis prism 11, the 2D brightness becomes optimum. Further, with the quarter waveplate 13 disposed on the light-emission side of the color synthesis prism 11 with the optical axis forming an angle of 45° against incoming polarized light, the stray light to be caused by the projection lens 20 is prevented.

Still further, on the light-emission stage of the projection lens 20, the quarter waveplate 32b is so provided that the optical axis is oriented in the direction of 135° against incoming polarized light. For use as the polarization conversion element 31, the wavelength-selective half waveplate 31a is so provided that two optical axes are oriented at angle of 0° or 90° against the incoming polarized light. With such a configuration, the non-polarized state of light is created with good efficiency, and this makes the color unevenness considerably less conspicuous and the brightness considerably less reduced.

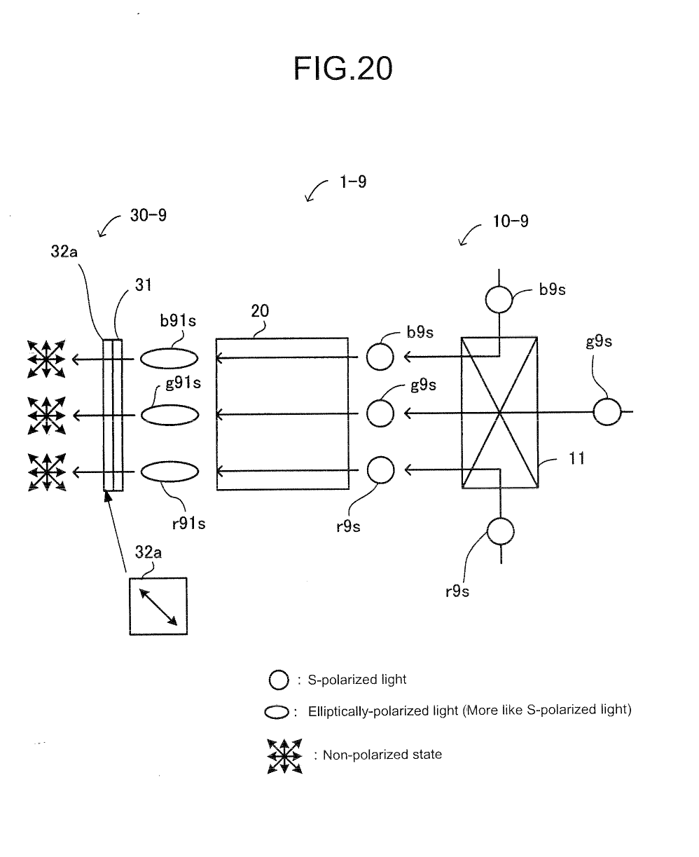

FIG. 20 is a diagram showing an exemplary configuration of a projection apparatus. A projection apparatus 1-9 includes a color synthesis section 10-9, the projection lens 20, and a polarization conversion section 30-9.

The polarization conversion section 30-9 includes the polarization conversion element 31, and the quarter waveplate 32a. The polarization conversion element 31 uses any of the wavelength-selective half waveplate 31a, the uniaxial organic material 31b, and the uniaxial crystal 31c described above by referring to FIGS. 7 to 11.

The SSS-model color synthesis prism 11 generates light being combined light of red S-polarized light r9s, green S-polarized light g9s, and blue S-polarized light b9s. The red S-polarized light r9s is S-polarized red light, the green S-polarized light g9s is S-polarized green light, and the blue S-polarized light b9s is S-polarized blue light.

The projection lens 20 receives the combined light, and then magnifies the combined light up to a predetermined magnification for emission. At this time, by passing through the projection lens 20, the red S-polarized light r9s in the combined light is converted into red elliptically-polarized light r91s (elliptically-polarized light more like S-polarized light). Further, by passing through the projection lens 20, the green S-polarized light g9s in the combined light is converted into green elliptically-polarized light g91s (elliptically-polarized light more like S-polarized light). Still further, by passing through the projection lens 20, the blue S-polarized light b9s in the combined light is converted into blue elliptically-polarized light b91s (elliptically-polarized light more like S-polarized light).

The polarization conversion element 31 puts, in the non-polarized state, the light coming from the projection lens 20, i.e., the red elliptically-polarized light r91s, the green elliptically-polarized light g91s, and the blue elliptically-polarized light b91s.

Alternatively, depending on how the projection lens 20 affects the polarization patterns of light, the quarter waveplate 32a may be provided on the light-emission stage of the polarization conversion element 31 to direct the optical axis in the direction of 135° against incoming polarized light. With the quarter waveplate 32a provided as such, the light is put in the better non-polarized state, and this makes color unevenness less conspicuous and brightness less reduced.

With the projection apparatus 1-9 configured as above, the light directed to the screen and the light reflected thereon is in the non-polarized state. This accordingly considerably improves the quality of 3D images with color unevenness made less conspicuous when 3D glasses are not tilted, and with color unevenness made less conspicuous and brightness made less reduced when the 3D glasses are tilted.

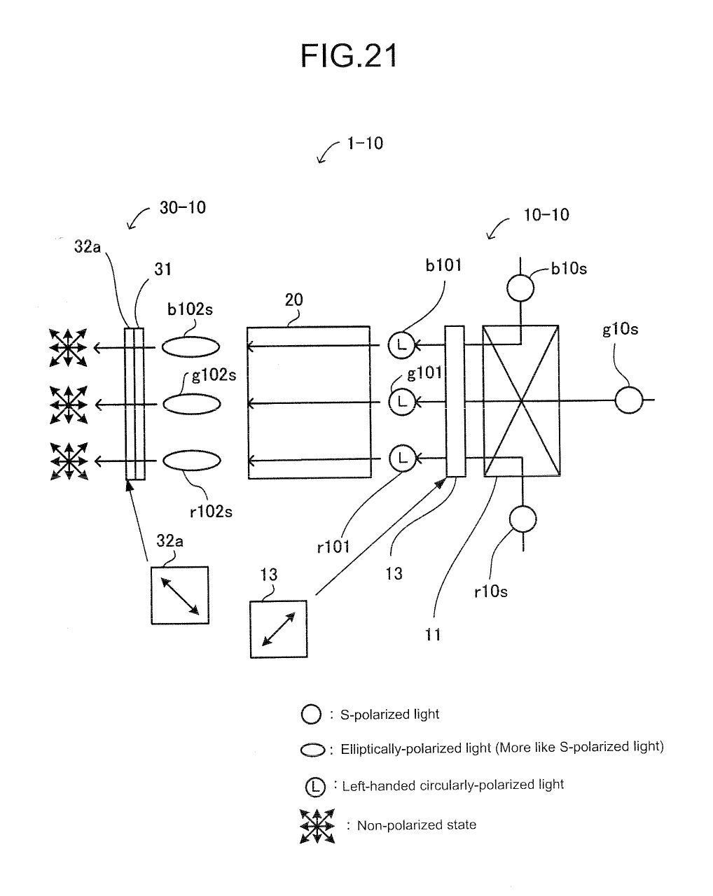

FIG. 21 is a diagram showing an exemplary configuration of a projection apparatus. A projection apparatus 1-10 includes a color synthesis section 10-10, the projection lens 20, and a polarization conversion section 30-10.

The color synthesis section 10-10 includes the color synthesis prism 11, and the quarter waveplate 13. The polarization conversion section 30-10 includes the polarization conversion element 31, and the quarter waveplate 32a. The polarization conversion element 31 uses any of the wavelength-selective half waveplate 31a, the uniaxial organic material 31b, and the uniaxial crystal 31c described above by referring to FIGS. 7 to 11.

The SSS-model color synthesis prism 11 generates light being combined light of red S-polarized light r10s, green S-polarized light g10s, and blue S-polarized light b10s. The red S-polarized light r10s is S-polarized red light, the green S-polarized light g10s is S-polarized green light, and the blue S-polarized light b1s is S-polarized blue light.

For prevention of the stray light described above, the quarter waveplate 13 is disposed on the light-emission side of the color synthesis prism 11, and is so oriented that the optical axis forms an angle of 45° against incoming polarized light. The quarter waveplate 13 converts the red S-polarized light r10s into left-handed circularly-polarized light, i.e., red left-handed circularly-polarized light r101, the green S-polarized light g10s into left-handed circularly-polarized light, i.e., green left-handed circularly-polarized light g101, and the blue S-polarized light b10s into left-handed circularly-polarized light, i.e., blue left-handed circularly-polarized light b101.

The projection lens 20 receives the combined light, and then magnifies the combined light up to a predetermined magnification for emission. At this time, by passing through the projection lens 20, the red left-handed circularly-polarized light r101 in the combined light is converted into red elliptically-polarized light r102s (elliptically-polarized light more like S-polarized light).

Further, by passing through the projection lens 20, the green left-handed circularly-polarized light g101 in the combined light is converted into green elliptically-polarized light g102s (elliptically-polarized light more like S-polarized light). Still further, by passing through the projection lens 20, the blue left-handed circularly-polarized light b101 in the combined light is converted into blue elliptically-polarized light b102s (elliptically-polarized light more like S-polarized light).

The polarization conversion element 31 puts, in the non-polarized state, the light coming from the projection lens 20, i.e., the red elliptically-polarized light r102s, the green elliptically-polarized light g102s, and the blue elliptically-polarized light b102s.

Alternatively, depending on how the projection lens 20 affects the polarization patterns of light, the quarter waveplate 32a may be provided on the light-emission stage of the polarization conversion element 31 to direct the optical axis in the direction of 135° against incoming polarized light. With the quarter waveplate 32a provided as such, the light is put in the better non-polarized state, and this makes color unevenness less conspicuous and brightness less reduced.

With the projection apparatus 1-10 configured as above, the light directed to the screen and the light reflected thereon is in the non-polarized state. This accordingly considerably improves the quality of 3D images with color unevenness made less conspicuous when 3D glasses are not and with color unevenness made less conspicuous and brightness made less reduced when the 3D glasses are tilted.

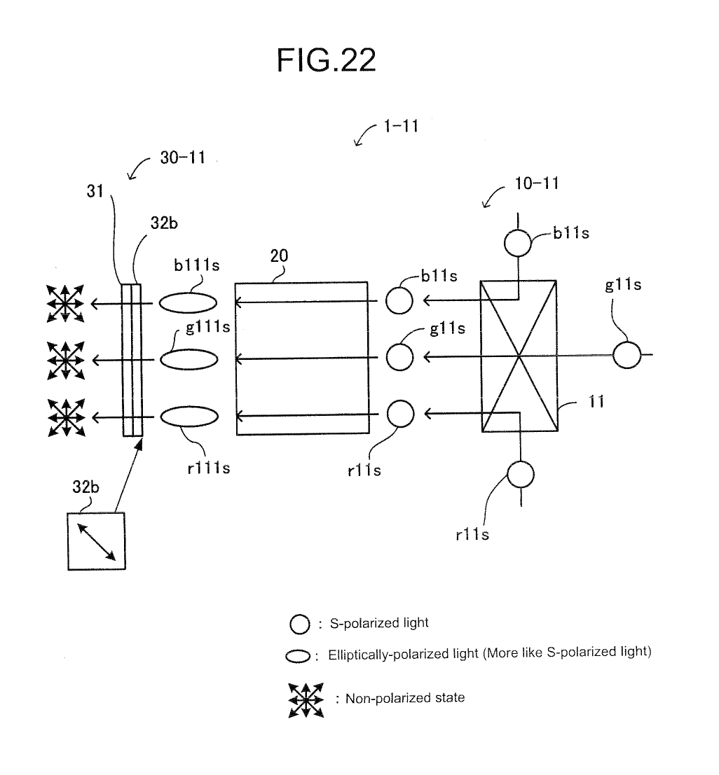

FIG. 22 is a diagram showing an exemplary configuration of a projection apparatus. A projection apparatus 1-11 includes a color synthesis section 10-11, the projection lens 20, and a polarization conversion section 30-11.

The polarization conversion section 30-11 includes the polarization conversion element 31, and the quarter waveplate 32b. The polarization conversion element 31 uses any of the wavelength-selective half waveplate 31a, the uniaxial organic material 31b, and the uniaxial crystal 31c described above by referring to FIGS. 7 to 11.

The SSS-model color synthesis prism 11 generates light being combined light of red S-polarized light r11s, green S-polarized light g11s, and blue S-polarized light b11s. The red S-polarized light r11s is S-polarized red light, the green S-polarized light g11s is S-polarized green light, and the blue S-polarized light b11s is S-polarized blue light.

The projection lens 20 receives the combined light, and then magnifies the combined light up to a predetermined magnification for emission. At this time, by passing through the projection lens 20, the red S-polarized light r11s in the combined light is converted into red elliptically-polarized light r111s (elliptically-polarized light more like S-polarized light). Further, by passing through the projection lens 20, the green S-polarized light g11s in the combined light is converted into green elliptically-polarized light g111s (elliptically-polarized light more like S-polarized light). Still further, by passing through the projection lens 20, the blue S-polarized light b11s in the combined light is converted into blue elliptically-polarized light b111s (elliptically-polarized light more like S-polarized light).

The polarization conversion element 31 puts, in the non-polarized state, the light coming from the projection lens 20, i.e., the red elliptically-polarized light r111s, the green elliptically-polarized light g111s, and the blue elliptically-polarized light b111s.

Alternatively, depending on how the projection lens 20 affects the polarization patterns of light, the quarter waveplate 32b may be provided on the light-incident stage of the polarization conversion element 31 to direct the optical axis in the direction of 135° against incoming polarized light. With the quarter waveplate 32b provided as such, the light is put in the better non-polarized state, and this makes color unevenness less conspicuous and brightness less reduced.

With the projection apparatus 1-11 configured as above, the light directed to the screen and the light reflected thereon is in the non-polarized state. This accordingly considerably improves the quality of 3D images with color unevenness made less conspicuous when 3D glasses are not tilted, and with color unevenness made less conspicuous and brightness made less reduced when the 3D glasses are tilted.

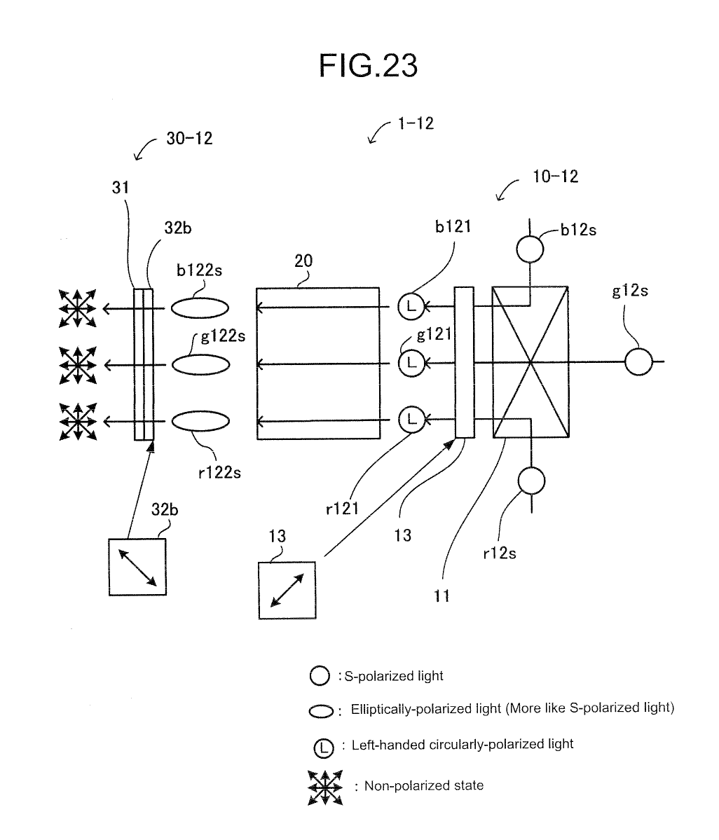

FIG. 23 is a diagram showing an exemplary configuration of a projection apparatus. A projection apparatus 1-12 includes a color synthesis section 10-12, the projection lens 20, and a polarization conversion section 30-12.

The color synthesis section 10-12 includes the color synthesis prism 11, and the quarter waveplate 13. The polarization conversion section 30-12 includes the polarization conversion element 31, and the quarter waveplate 32b. The polarization conversion element 31 uses any of the wavelength-selective half waveplate 31a, the uniaxial organic material 31b, and the uniaxial crystal 31c described above by referring to FIGS. 7 to 11.

The SSS-model color synthesis prism 11 generates light being combined light of red S-polarized light r12s, green S-polarized light g12s, and blue S-polarized light b12s. The red S-polarized light r12s is S-polarized red light, the green S-polarized light g12s is S-polarized green light, and the blue S-polarized light b12s is S-polarized blue light.

For prevention of the stray light described above, the quarter waveplate 13 is disposed on the light-emission side of the color synthesis prism 11, and is so oriented that the optical axis forms an angle of 45° against incoming polarized light. The quarter waveplate 13 converts the red S-polarized light r12s into left-handed circularly-polarized light, i.e., red left-handed circularly-polarized light r121, the green S-polarized light g12s into left-handed circularly-polarized light, i.e., green left-handed circularly-polarized light g121, and the blue S-polarized light b12s into left-handed circularly-polarized light, i.e., blue left-handed circularly-polarized light b121.

The projection lens 20 receives the combined light, and then magnifies the combined light up to a predetermined magnification for emission. At this time, by passing through the projection lens 20, the red left-handed circularly-polarized light r121 in the combined light is converted into red elliptically-polarized light r122s (elliptically-polarized light more like S-polarized light).

Further, by passing through the projection lens 20, the green left-handed circularly-polarized light g121 in the combined light is converted into green elliptically-polarized light g122s (elliptically-polarized light more like S-polarized light). Still further, by passing through the projection lens 20, the blue left-handed circularly-polarized light b121 in the combined light is converted into blue elliptically-polarized light b122s (elliptically-polarized light more like S-polarized light).

The polarization conversion element 31 puts, in the non-polarized state, the light coming from the projection lens 20, i.e., the red elliptically-polarized light r122s, the green elliptically-polarized light g122s, and the blue elliptically-polarized light b122s.

Alternatively, depending on how the projection lens 20 affects the polarization patterns of light, the quarter waveplate 32b may be provided on the light-incident stage of the polarization conversion element 31 to direct the optical axis in the direction of 135° against incoming polarized light. With the quarter waveplate 32b provided as such, the light is put in the better non-polarized state, and this makes color unevenness less conspicuous and brightness less reduced.

With the projection apparatus 1-12 configured as above, the light directed to the screen and the light reflected thereon is in the non-polarized state. This accordingly considerably improves the quality of 3D images with color unevenness made less conspicuous when 3D glasses are not tilted, and with color unevenness made less conspicuous and brightness made less reduced when the 3D glasses are tilted.

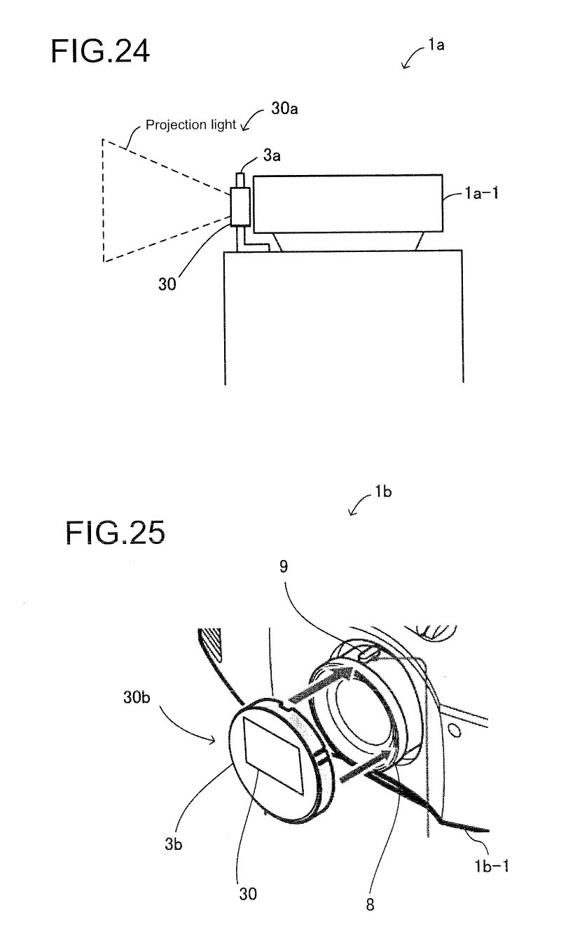

Described next is the placement of the polarization conversion section 30 in the projection apparatus 1. FIG. 24 is a diagram showing an exemplary placement. A projection apparatus 1a includes an apparatus body section 1a-1 (projector body), and a polarization converter 30a. The polarization converter 30a is attachable from the outside to the apparatus body section 1a-1.

The polarization converter 30a includes the polarization conversion section 30, and a mechanism frame component 3a. The mechanism frame component 3a is mounted with the polarization conversion section 30. The mechanism frame component 3a is exemplified by L-shaped hardware, and is fixed to the apparatus body section 1a-1 at any appropriate position where the polarization conversion section 30 comes at the projection position of a projection lens in the apparatus body section 1a-1.

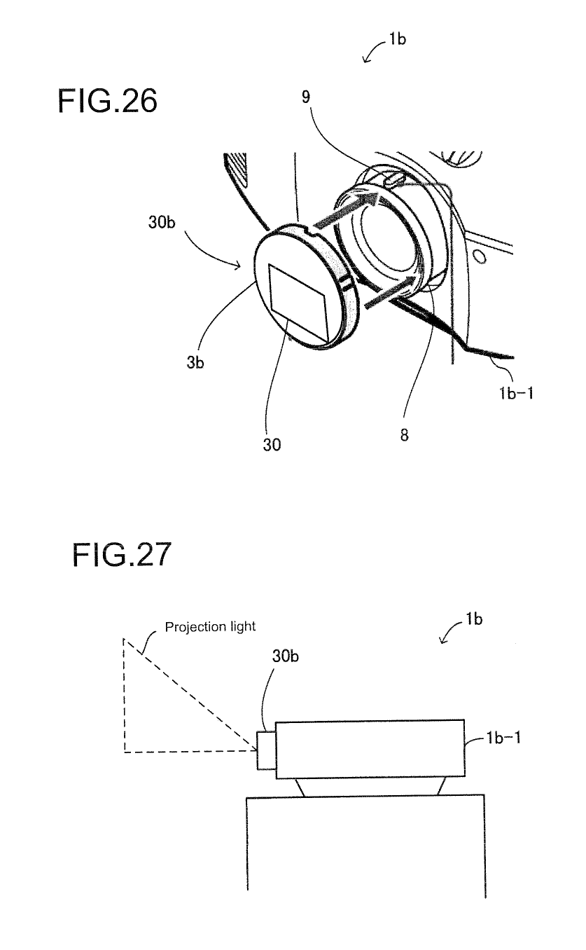

FIGS. 25 and 26 are each a diagram showing another exemplary placement. A projection apparatus 1b includes an apparatus body section 1b-1 (projector body), and a polarization converter 30b. The polarization converter 30b is attachable from the outside to the apparatus body section 1b-1.

The polarization converter 30b includes the polarization conversion section 30, and a mechanism frame component 3b. The mechanism frame component 3b is mounted with the polarization conversion section 30. The mechanism frame component 3b is so shaped as to be attached to a focus ring 8 of a projection lens in the apparatus body section 1b-1.

The polarization conversion section 30 is provided to the mechanism frame component 3b to be closer to one side of the mechanism frame component 3b including the projection center position of the projection lens.

FIGS. 25 and 26 each show the state in which such a converter 30b is attached to the focus ring 8. FIG. 25 shows an example in which the window of the polarization conversion section 30 is on the upper side, i.e., on the side of a shift dial 9. FIG. 26 shows an example in which the window of the polarization conversion section 30 is on the lower side.

FIGS. 27 to 30 each show an exemplary projection state. FIG. 27 shows the projection state of the projection apparatus 1b with the attachment of the polarization converter 30b as described above by referring to FIG. 25, i.e., the polarization converter 30b is so attached that the window of the polarization conversion section 30 is on the upper side (on the shift dial 9 side). In this case, in the projection state of FIG. 27, the projection lens of the projection apparatus 1b is directed upward for upward projection with respect to the screen.

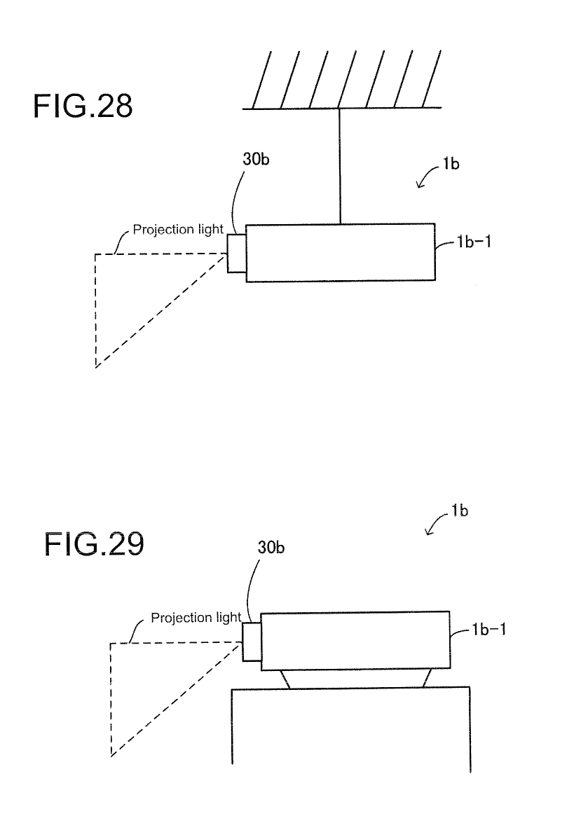

On the other hand, in the example of FIG. 28, the projection apparatus 1b is hung from the ceiling for downward projection with respect to the screen. When the projection apparatus 1b is hung from the ceiling as shown in FIG. 28, i.e., the top surface of the apparatus is connected to hardware for hanging use, the polarization converter 30b is so attached that the window of the polarization conversion section 30 is on the lower side, i.e., on the side opposite to the shift dial 9 as shown in FIG. 26.

Herein, to be hung from the ceiling, the projection apparatus 1b is often directed upside down because the bottom surface of the apparatus is formed with a screw hole for the hardware for hanging use. In this case, the polarization converter 30b is so attached that the window of the polarization conversion section 30 is on the upper side, i.e., on the shift dial 9 side as shown in FIG. 25.

Note that for downward projection from the above, as an alternative to the case of hanging the projection apparatus 1b from the ceiling, the projection apparatus 1b may be disposed on a high rack. In this case, the window comes on the lower side, i.e., on the side opposite to the shift dial 9, as shown in FIG. 26.

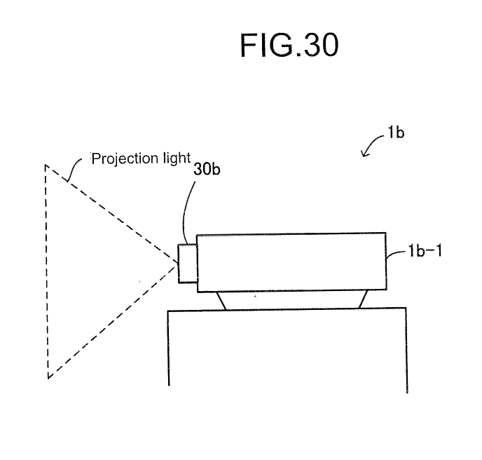

FIG. 29 shows the projection state of the projection apparatus 1b when the polarization converter 30b is so attached that the window of the polarization conversion section 30 comes on the lower side as described above by referring to FIG. 26. In this case, the projection lens of the projection apparatus 1b is directed downward for downward projection with respect to the screen. Note that FIG. 30 shows the case of projection in the straight direction, and in this case, the polarization converter 30b may be attached as shown in FIG. 25 or 26.

The projection apparatus 1 uses a light source, which is exemplified by a light source with wide-range-wavelength continuous emission spectrum, or a light source using wide-range-wavelength continuous emission spectrum for RGB projection light. A general LCD projector uses a continuous-wavelength light source such as a UHP (Ultra High Performance) lamp or an Xe (xenon) lamp. Therefore, the functions of the projection apparatus 1 are applicable practically to almost every LCD projector.

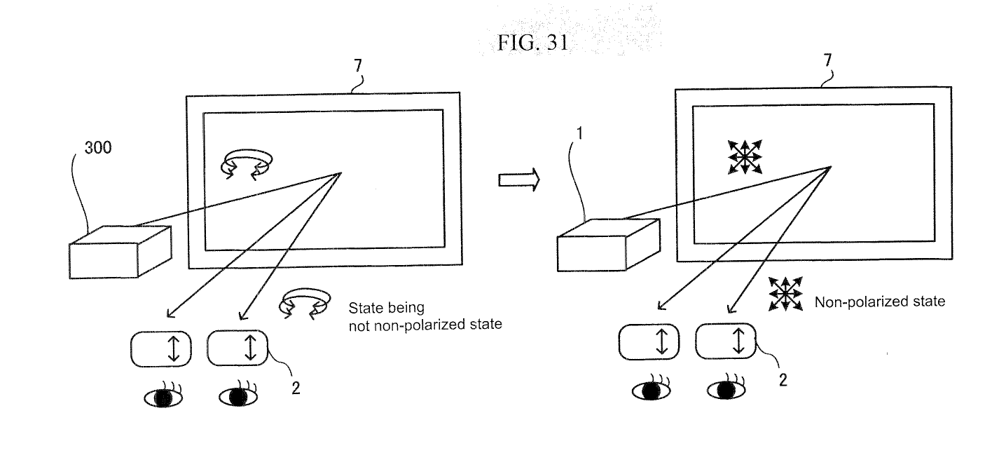

Described next are differences between the previous technology and the present technology. FIG. 31 is a conceptual view of projection by each projection apparatus. With a projection apparatus 300 of the previous technology, as for light coming therefrom, light entering the screen 7 and light reflected on the screen 7 are not put in the non-polarized state. On the other hand, with the projection apparatus 1 according to the embodiment of the present technology, as for light coming therefrom, light entering the screen 7 and light reflected on the screen 7 are both put in the non-polarized state.

As described above, the projection apparatus 1 is so configured as to put the RGB projection light entirely in the non-polarized state. With the projection apparatus of the previous technology, the RGB light is simply linearly aligned to be directed along the same direction, but the projection apparatus 1 puts the RGB light entirely in the non-polarized state.

This thus makes any color unevenness of 3D images considerably less conspicuous through 3D glasses with no tilt thereof. Moreover, with a tilt of about ±25° of the 3D glasses (expected use range for customers), for example, this makes any color unevenness of the 3D images considerably less conspicuous and brightness considerably less reduced.

Further, the projection apparatus 1 is ready for use in a whole category of LCD projectors adopting the 3D active-shutter technology, optical members, or the usage environment, and thus has high compatibility and is excellent in serviceability. That is, the projection apparatus 1 is ready for use in a whole category of LCD projections including reflective and transmissive LCDs, and also in a whole category of color synthesis prisms (SPS-model and SSS-model), for example.

Still further, a plastic lens may be used for the projection lens and the like, and the use of a whole category of screens is possible, e.g., silver screen, bead screen, and mat screen. Still further, the polarization conversion function of the projection apparatus 1 may be additionally provided later by a customer, and thus is high in flexibility and convenience, and no apparatus modification is expected.

The present technology is also in the following structures.

(1) A projection apparatus, including:

a color synthesis section configured to combine three-primary color light;

a projection lens configured to emit light provided by the color synthesis section; and

a polarization conversion section disposed on a light-emission side of the projection lens, the polarization conversion section being configured to put the color light provided by the projection lens in a non-polarized state.

(2) The projection apparatus according to (1), in which

the polarization conversion section includes a polarization conversion element, the polarization conversion element being any one of a wavelength-selective half waveplate, a uniaxial organic material, and a uniaxial crystal, the wavelength-selective half waveplate producing a phase shift of π with respect to light with a predetermined wavelength, the uniaxial organic material being an organic material having one optical axis, and the uniaxial crystal being a crystal having one optical axis.

(3) The projection apparatus according to any one of (1) and (2), in which

the color synthesis section includes
a color synthesis prism,
a half waveplate disposed on a side of the color synthesis prism where green light enters, and
a first quarter waveplate disposed between a light-incident side of the projection lens and a light-emission side of the color synthesis prism,

the polarization conversion section includes
the polarization conversion element, and
a second quarter waveplate disposed between a light-incident side of the polarization conversion element and a light-emission side of the projection lens,

the half waveplate converts S-polarized green light into P-polarized green light,

the color synthesis prism combines red S-polarized light being S-polarized red light, green P-polarized light being the P-polarized green light, and blue S-polarized light being S-polarized blue light,

the first quarter waveplate converts the red S-polarized light into red left-handed circularly-polarized light being left-handed circularly-polarized light, the green P-polarized light into green right-handed circularly-polarized light being right-handed circularly-polarized light, and the blue S-polarized light into blue left-handed circularly-polarized light being left-handed circularly-polarized light, and

the polarization conversion element and the second quarter waveplate put red, green, and blue elliptically-polarized light in the non-polarized state, the red, green, and blue elliptically-polarized light being the red and blue left-handed circularly-polarized light and the green right-handed circularly-polarized light each elliptically-polarized after passage through the projection lens.

(4) The projection apparatus according to any one of (1) and (2), in which

the color synthesis section includes
a color synthesis prism, and
a half waveplate disposed on a side of the color synthesis prism where green light enters,

the half waveplate converts S-polarized green light into P-polarized green light,

the color synthesis prism combines red S-polarized light being S-polarized red light, green P-polarized light being the P-polarized green light, and blue S-polarized light being S-polarized blue light, and

the polarization conversion element puts red, green, and blue elliptically-polarized light in the non-polarized state, the red, green, and blue elliptically-polarized light being the red and blue S-polarized light and the green P-polarized light each elliptically-polarized after passage through the projection lens.

(5) The projection apparatus according to any one of (1) and (2), in which

the color synthesis section includes
a color synthesis prism,
a half waveplate disposed on a side of the color synthesis prism where green light enters, and
a quarter waveplate disposed between a light-incident side of the projection lens and a light-emission side of the color synthesis prism,

the half waveplate converts S-polarized green light into P-polarized green light,

the color synthesis prism combines red S-polarized light being S-polarized red light, green P-polarized light being the P-polarized green light, and blue S-polarized light being S-polarized blue light,

the quarter waveplate converts the red S-polarized light into red left-handed circularly-polarized light being left-handed circularly-polarized light, the green P-polarized light into green right-handed circularly-polarized light being right-handed circularly-polarized light, and the blue S-polarized light into blue left-handed circularly-polarized light being left-handed circularly-polarized light, and

the polarization conversion element puts red, green, and blue elliptically-polarized light in the non-polarized state, the red, green, and blue elliptically-polarized light being the red and blue left-handed circularly-polarized light and the green right-handed circularly-polarized light each elliptically-polarized after passage through the projection lens.

(6) The projection apparatus according to any one of (1) and (2), in which

the color synthesis section includes a color synthesis prism,

the color synthesis prism combines red S-polarized light being S-polarized red light, green S-polarized light being S-polarized green light, and blue S-polarized light being S-polarized blue light, and

the polarization conversion element puts red, green, and blue elliptically-polarized light in the non-polarized state, the red, green, and blue elliptically-polarized light being the red, green, and blue S-polarized light each elliptically-polarized after passage through the projection lens.

(7) The projection apparatus according to any one of (1) and (2), in which

the color synthesis section includes
a color synthesis prism, and
a quarter waveplate disposed between a light-incident side of the projection lens and a light-emission side of the color synthesis prism,

the color synthesis prism combines red S-polarized light being S-polarized red light, green S-polarized light being S-polarized green light, and blue S-polarized light being S-polarized blue light,

the quarter waveplate converts the red S-polarized light into red left-handed circularly-polarized light being left-handed circularly-polarized light, the green S-polarized light into green left-handed circularly-polarized light being left-handed circularly-polarized light, and the blue S-polarized light into blue left-handed circularly-polarized light being left-handed circularly-polarized light, and

the polarization conversion element puts red, green, and blue elliptically-polarized light in the non-polarized state, the red, green, and blue elliptically-polarized light being the red, green, and blue left-handed circularly-polarized light each elliptically-polarized after passage through the projection lens.

(8) The projection apparatus according to any one of (1) and (2), in which

the color synthesis section includes
a color synthesis prism, and
a half waveplate disposed on a light-incident side of the color synthesis prism where green light enters,

the polarization conversion section includes
a quarter waveplate, and
the polarization conversion element disposed between a light-incident side of the quarter waveplate and a light-emission side of the projection lens,

the half waveplate converts S-polarized green light into P-polarized green light,

the color synthesis prism combines red S-polarized light being S-polarized red light, green P-polarized light being the P-polarized green light, and blue S-polarized light being S-polarized blue light, and

the polarization conversion element and the quarter waveplate put red, green, and blue elliptically-polarized light in the non-polarized state, the red, green, and blue elliptically-polarized light being the red and blue S-polarized light and the green P-polarized light each elliptically-polarized after passage through the projection lens.

(9) The projection apparatus according to any one of (1) and (2), in which

the color synthesis section includes
a color synthesis prism,
a half waveplate disposed on a side of the color synthesis prism where green light enters, and
a first quarter waveplate disposed between a light-incident side of the projection lens and a light-emission side of the color synthesis prism,

the polarization conversion section includes
a second quarter waveplate, and
the polarization conversion element disposed between a light-incident side of the second quarter plate and a light-emission side of the projection lens,

the half waveplate converts S-polarized green light into P-polarized green light,

the color synthesis prism combines red S-polarized light being S-polarized red light, green P-polarized light being the P-polarized green light, and blue S-polarized light being S-polarized blue light,

the first quarter waveplate converts the red S-polarized light into red left-handed circularly-polarized light being left-handed circularly-polarized light, the green P-polarized light into green right-handed circularly-polarized light being right-handed circularly-polarized light, and the blue S-polarized light into blue left-handed circularly-polarized light being left-handed circularly-polarized light, and

the polarization conversion element and the second quarter waveplate put red, green, and blue elliptically-polarized light in the non-polarized state, the red, green, and blue elliptically-polarized light being the red and blue left-handed circularly-polarized light and the green right-handed circularly-polarized light each elliptically-polarized after passage through the projection lens.

(10) The projection apparatus according to any one of (1) and (2), in which

the color synthesis section includes
a color synthesis prism, and
a half waveplate disposed on a side of the color synthesis prism where green light enters,

the polarization conversion section includes
the polarization conversion element, and
a quarter waveplate disposed between a light-incident side of the polarization conversion element and a light-emission side of the projection lens,

the half waveplate converts S-polarized green light into P-polarized green light,

the color synthesis prism combines red S-polarized light being S-polarized red light, green P-polarized light being the P-polarized green light, and blue S-polarized light being S-polarized blue light, and

the polarization conversion element and the quarter waveplate put red, green, and blue elliptically-polarized light in the non-polarized state, the red, green, and blue elliptically-polarized light being the red and blue S-polarized light and the green P-polarized light each elliptically-polarized after passage through the projection lens.

(11) The projection apparatus according to any one of (1) and (2), in which

the polarization conversion section includes
a quarter waveplate, and
the polarization conversion element disposed between a light-incident side of the quarter waveplate and a light-emission side of the projection lens,

the color synthesis section includes a color synthesis prism,

the color synthesis prism combines red S-polarized light being S-polarized red light, green S-polarized light being S-polarized green light, and blue S-polarized light being S-polarized blue light, and

the polarization conversion element and the quarter waveplate put red, green, and blue elliptically-polarized light in the non-polarized state, the red, green, and blue elliptically-polarized light being the red, green, and blue S-polarized light each elliptically-polarized after passage through the projection lens.

(12) The projection apparatus according to any one of (1) and (2), in which

the color synthesis section includes
a color synthesis prism, and
a first quarter waveplate disposed between a light-incident side of the projection lens and a light-emission side of the color synthesis prism,

the polarization conversion section includes
a second quarter waveplate, and
the polarization conversion element disposed between a light-incident side of the second quarter waveplate and a light-emission side of the projection lens,

the color synthesis prism combines red S-polarized light being S-polarized red light, green S-polarized light being S-polarized green light, and blue S-polarized light being S-polarized blue light,

the first quarter waveplate converts the red S-polarized light into red left-handed circularly-polarized light being left-handed circularly-polarized light, the green S-polarized light into green left-handed circularly-polarized light being left-handed circularly-polarized light, and the blue S-polarized light into blue left-handed circularly-polarized light being left-handed circularly-polarized light, and

the polarization conversion element and the second quarter waveplate put red, green, and blue elliptically-polarized light in the non-polarized state, the red, green, and blue elliptically-polarized light being the red, green, and blue left-handed circularly-polarized light each elliptically-polarized after passage through the projection lens.

(13) The projection apparatus according to any one of (1) and (2), in which

the polarization conversion section includes
the polarization conversion element, and
a quarter waveplate disposed between a light-incident side of the polarization polarization conversion element and a light-emission side of the projection lens,

the color synthesis section includes a color synthesis prism,

the color synthesis prism combines red S-polarized light being S-polarized red light, green S-polarized light being S-polarized green light, and blue S-polarized light being S-polarized blue light, and

the polarization conversion element and the quarter waveplate put red, green, and blue elliptically-polarized light in the non-polarized state, the red, green, and blue elliptically-polarized light being the red, green, and blue S-polarized light each elliptically-polarized after passage through the projection lens.

(14) The projection apparatus according to any one of (1) and (2), in which

the color synthesis section includes
a color synthesis prism, and
a first quarter waveplate disposed between a light-incident side of the projection lens and a light-emission side of the color synthesis prism,

the polarization conversion section includes
the polarization conversion element, and
a second quarter waveplate disposed between a light-incident side of the polarization conversion element and a light-emission side of the projection lens,

the color synthesis prism combines red S-polarized light being S-polarized red light, green S-polarized light being S-polarized green light, and blue S-polarized light being S-polarized blue light,

the first quarter waveplate converts the red S-polarized light into red left-handed circularly-polarized light being left-handed circularly-polarized light, the green S-polarized light into green left-handed circularly-polarized light being left-handed circularly-polarized light, and the blue S-polarized light into blue left-handed circularly-polarized light being left-handed circularly-polarized light, and

the polarization conversion element and the second quarter waveplate put red, green, and blue elliptically-polarized light in the non-polarized state, the red, green, and blue elliptically-polarized light being the red, green, and blue left-handed circularly-polarized light each elliptically-polarized after passage through the projection lens.

(15) The projection apparatus according to any one of (1) to (14), in which

the polarization conversion section is mounted to an outer frame component, the outer frame component being attachable from an outside to a focus ring of the projection lens, and is provided at a position closer to a side of the outer frame component including a projection center position of the projection lens.

The present disclosure contains subject matter related to that disclosed in Japanese Priority Patent Application JP 2011-247055 filed in the Japan Patent Office on Nov. 11, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A projection apparatus, comprising:
a color synthesis section configured to combine three-primary color light;
a projection lens configured to emit light provided by the color synthesis section; and
a polarization conversion section disposed on a light-emission side of the projection lens, the polarization conversion section being configured to put the color light provided by the projection lens in a non-polarized state.

2. The projection apparatus according to claim 1, wherein
the polarization conversion section includes a polarization conversion element, the polarization conversion element being any one of a wavelength-selective half waveplate, a uniaxial organic material, and a uniaxial crystal, the wavelength-selective half waveplate producing a phase shift of π with respect to light with a predetermined wavelength, the uniaxial organic material being an organic material having one optical axis, and the uniaxial crystal being a crystal having one optical axis.

3. The projection apparatus according to claim 2, wherein
the color synthesis section includes
a color synthesis prism,
a half waveplate disposed on a side of the color synthesis prism where green light enters, and
a first quarter waveplate disposed between a light-incident side of the projection lens and a light-emission side of the color synthesis prism,
the polarization conversion section includes
the polarization conversion element, and
a second quarter waveplate disposed between a light-incident side of the polarization conversion element and a light-emission side of the projection lens,
the half waveplate converts S-polarized green light into P-polarized green light,
the color synthesis prism combines red S-polarized light being S-polarized red light, green P-polarized light being the P-polarized green light, and blue S-polarized light being S-polarized blue light,
the first quarter waveplate converts the red S-polarized light into red left-handed circularly-polarized light, being left-handed circularly-polarized light, the green P-polarized light into green right-handed circularly-polarized light being right-handed circularly-polarized light, and the blue S-polarized light into blue left-handed circularly-polarized light being left-handed circularly-polarized light, and
the polarization conversion element and the second quarter waveplate put red, green, and blue elliptically-polarized light in the non-polarized state, the red, green, and blue elliptically-polarized light being the red and blue left-handed circularly-polarized light and the green right-handed circularly-polarized light each elliptically-polarized after passage through the projection lens.

4. The projection apparatus according to claim 2, wherein
the color synthesis section includes
a color synthesis prism, and
a half waveplate disposed on a side of the color synthesis prism where green light enters,
the half waveplate converts S-polarized green light into P-polarized green light,
the color synthesis prism combines red S-polarized light being S-polarized red light, green P-polarized light being the P-polarized green light, and blue S-polarized light being S-polarized blue light, and
the polarization conversion element puts red, green, and blue elliptically-polarized light in the non-polarized state, the red, green, and blue elliptically-polarized light being the red and blue S-polarized light and the green P-polarized light each elliptically-polarized after passage through the projection lens.

5. The projection apparatus according to claim 2, wherein
the color synthesis section includes
a color synthesis prism,
a half waveplate disposed on a side of the color synthesis prism where green light enters, and
a quarter waveplate disposed between a light-incident side of the projection lens and a light-emission side of the color synthesis prism,
the half waveplate converts S-polarized green light into P-polarized green light,
the color synthesis prism combines red S-polarized light being S-polarized red light, green P-polarized light being the P-polarized green light, and blue S-polarized light being S-polarized blue light,
the quarter waveplate converts the red S-polarized light into red left-handed circularly-polarized light being left-handed circularly-polarized light, the green P-polarized light into green right-handed circularly-polarized light being right-handed circularly-polarized light, and the blue S-polarized light into blue left-handed circularly-polarized light being left-handed circularly-polarized light, and
the polarization conversion element puts red, green, and blue elliptically-polarized light in the non-polarized state, the red, green, and blue elliptically-polarized light being the red and blue left-handed circularly-polarized light and the green right-handed circularly-polarized light each elliptically-polarized after passage through the projection lens.

6. The projection apparatus according to claim 2, wherein
the color synthesis section includes a color synthesis prism,
the color synthesis prism combines red S-polarized light being S-polarized red light, green S-polarized light being S-polarized green light, and blue S-polarized light being S-polarized blue light, and
the polarization conversion element puts red, green, and blue elliptically-polarized light in the non-polarized state, the red, green, and blue elliptically-polarized light being the red, green, and blue S-polarized light each elliptically-polarized after passage through the projection lens.

7. The projection apparatus according to claim 2, wherein
the color synthesis section includes
a color synthesis prism, and
a quarter waveplate disposed between a light-incident side of the projection lens and a light-emission side of the color synthesis prism,
the color synthesis prism combines red S-polarized light being S-polarized red light, green S-polarized light being S-polarized green light, and blue S-polarized light being S-polarized blue light,
the quarter waveplate converts the red S-polarized light into red left-handed circularly-polarized light being left-handed circularly-polarized light, the green S-polarized light into green left-handed circularly-polarized light being left-handed circularly-polarized light, and the blue S-polarized light into blue left-handed circularly-polarized being left-handed circularly-polarized light, and
the polarization conversion element puts red, green, and blue elliptically-polarized light in the non-polarized state, the red, green, and blue elliptically-polarized light being the red, green, and blue left-handed circularly-polarized light each elliptically-polarized after passage through the projection lens.

8. The projection apparatus according to claim 2, wherein
the color synthesis section includes
a color synthesis prism, and
a half waveplate disposed on a light-incident side of the color synthesis prism where green light enters,
the polarization conversion section includes
a quarter waveplate, and
the polarization conversion element disposed between a light-incident side of the quarter waveplate and a light-emission side of the projection lens,
the half waveplate converts S-polarized green light into P-polarized green light,
the color synthesis prism combines red S-polarized light being S-polarized red light, green P-polarized light being the P-polarized green light, and blue S-polarized light being S-polarized blue light, and
the polarization conversion element and the quarter waveplate put red, green, and blue elliptically-polarized light in the non-polarized state, the red, green, and blue elliptically-polarized light being the red and blue S-polarized light and the green P-polarized light each elliptically-polar after passage through the projection lens.

9. The projection apparatus according to claim 2, wherein
the color synthesis section includes
a color synthesis prism,
a half waveplate disposed on a side of the color synthesis prism where green light enters, and
a first quarter waveplate disposed between a light-incident side of the projection lens and a light-emission side of the color synthesis prism,
the polarization conversion section includes
second quarter waveplate, and
the polarization conversion element disposed between a light-incident side of the second quarter plate and a light-emission side of the projection lens,
the half waveplate converts S-polarized green light into P-polarized green light,
the color synthesis prism combines red S-polarized light being S-polarized red light, green P-polarized light being the P-polarized green light, and blue S-polarized light being S-polarized blue light,
the first quarter waveplate converts the red S-polarized light into red left-handed circularly-polarized light being left-handed circularly-polarized light, the green P-polarized light into green right-handed circularly-polarized light being right-handed circularly-polarized light, and the blue S-polarized light into blue left-handed circularly-polarized light being left-handed circularly-polarized light, and
the polarization conversion element and the second quarter waveplate put red, green, and blue elliptically-polarized light in the non-polarized state, the red, green, and blue elliptically-polarized light being the red and blue left-handed circularly-polarized light and the green right-handed circularly-polarized light each elliptically-polarized after passage through the projection lens.

10. The projection apparatus according to claim 2, wherein
the color synthesis section includes
a color synthesis prism, and
a half waveplate disposed on a side of the color synthesis prism where green light enters,
the polarization conversion section includes
the polarization conversion element, and
a quarter waveplate disposed between a light-incident side of the polarization conversion element and a light-emission side of the projection lens,
the half waveplate converts S-polarized green light into P-polarized green light,
the color synthesis prism combines red S-polarized light being S-polarized red light, green P-polarized light being the P-polarized green light, and blue S-polarized light being S-polarized blue light, and
the polarization conversion element and the quarter waveplate put red, green, and blue elliptically-polarized light in the non-polarized state, the red, green, and blue elliptically-polarized light being the red and blue S-polarized light and the green P-polarized light each elliptically-polarized after passage through the projection lens.

11. The projection apparatus according to claim 2, wherein
the polarization conversion section includes
a quarter waveplate, and
the polarization conversion element disposed between a light-incident side of the quarter waveplate and a light-emission side of the projection lens,
the color synthesis section includes a color synthesis prism,
the color synthesis prism combines red S-polarized light being S-polarized red light, green S-polarized light being S-polarized green light, and blue S-polarized light being S-polarized blue light, and
the polarization conversion element and the quarter waveplate put red, green, and blue elliptically-polarized light in the non-polarized state, the red, green, and blue elliptically-polarized light being the red, green, and blue S-polarized light each elliptically-polarized after passage through the projection lens.

12. The projection apparatus according to claim 2, wherein
the color synthesis section includes
a color synthesis prism, and
a first quarter waveplate disposed between a light-incident side of the projection lens and a light-emission side of the color synthesis prism,
the polarization conversion section includes
a second quarter waveplate, and
the polarization conversion element disposed between a light-incident side of the second quarter waveplate and a light-emission side of the projection lens,
the color synthesis prism combines red S-polarized light being S-polarized red light, green S-polarized light being S-polarized green light, and blue S-polarized light being S-polarized blue light,
the first quarter waveplate converts the red S-polarized light into red left-handed circularly-polarized light being left-handed circularly-polarized light, the green S-polarized light into green left-handed circularly-polarized light being left-handed circularly-polarized light, and the blue S-polarized light into blue left-handed circularly-polarized light being left-handed light, and
the polarization conversion element and the second quarter waveplate put red, green, and blue elliptically-polarized light in the non-polarized state, the red, green, and blue elliptically-polarized light being the red, green, and blue left-handed circularly-polarized light each elliptically-polarized after passage through the projection lens.

13. The projection apparatus according to claim 2, wherein
the polarization conversion section includes
the polarization conversion element, and
a quarter waveplate disposed between a light-incident side of the polarization conversion element and a light-emission side of the projection lens,
the color synthesis section includes a color synthesis prism,
the color synthesis prism combines red S-polarized light being S-polarized red light, green S-polarized light being S-polarized green light, and blue S-polarized light being S-polarized blue light, and
the polarization conversion element and the quarter waveplate put red, green, and blue elliptically-polarized light in the non-polarized state, the red, green, and blue elliptically-polarized light being the red, green, and blue S-polarized light each elliptically-polarized after passage through the projection lens.

14. The projection apparatus according to claim 2, wherein
the color synthesis section includes
a color synthesis prism, and
a first quarter waveplate disposed between a light-incident side of the projection lens and a light-emission side of the color synthesis prism,
the polarization conversion section includes
the polarization conversion element, and
a second quarter waveplate disposed between a light-incident side of the polarization conversion element and a light-emission side of the projection lens,
the color synthesis prism combines red S-polarized light being S-polarized red light, green S-polarized light being S-polarized green light, and blue S-polarized light being S-polarized blue light,
the first quarter waveplate converts the red S-polarized light into red left-handed circularly-polarized light being left-handed circularly-polarized light, the green S-polarized light into green left-handed circularly-polarized light being left-handed circularly-polarized light, and the blue S-polarized light into blue left-handed circularly-polarized light being left-handed circularly-polarized light, and
the polarization conversion element and the second quarter waveplate put red, green, and blue elliptically-polarized light in the non-polarized state, the red, green, and blue elliptically-polarized light being the red, green, and blue left-handed circularly-polarized light each elliptically-polarized after passage through the projection lens.

15. The projection apparatus according to claim 1, wherein
the polarization conversion section is mounted to an outer frame component, the outer frame component being attachable from an outside to a focus ring of the projection lens, and is provided at a position closer to a side of the outer frame component including a projection center position of the projection lens.
